(19) United States
(12) Patent Application Publication
(10) Pub. No.: US 2026/0329636 A1
(43) Pub. Date: Oct. 22, 2026

(54) SYSTEM

(71) Applicant: SoftBank Group Corp., Tokyo (JP)

(72) Inventor: Kensuke FUKUSHIMA, Tokyo (JP)

(73) Assignee: SoftBank Group Corp., Tokyo (JP)

(21) Appl. No.: 19/649,135

(22) Filed: Apr. 16, 2026

(30) Foreign Application Priority Data
Apr. 22, 2025 (JP) 2025-070932

(51) Int. Cl. G06F 9/48; G06N 3/0455; G06N 3/0475; G16Y 20/10; G16Y 40/40

(52) U.S. Cl. CPC G06F 9/4881; G06N 3/0455; G06N 3/0475; G16Y 20/10; G16Y 40/40

(57) ABSTRACT

The present invention relates to a sightseeing DX platform that acquires and analyzes biometric data and a movement history of a tourist in real time, dynamically proposes an optimal sightseeing route, a means of transportation, a rest spot, and a drop-in destination according to a fatigue level, a stress value, a preference, a current location, a congestion status, and the like of each tourist using generative AI, and realizes demand decentralization by congestion prediction AI and automatic generation of a personalized service based on consumer behavior, an attribute, and the like, and is characterized by simultaneously achieving an improvement in satisfaction of the tourist, maximization of a ripple effect on a regional economy, and construction of a sustainable sightseeing model.

### CROSS-REFERENCE TO RELATED APPLICATION

The present application claims priority to and incorporates by reference the entire contents of Japanese Patent Application No. 2025-070932 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that when a tourist visits a sightseeing area, the quality of a travel experience is likely to deteriorate due to accumulation of fatigue and stress, waiting time and poor movement efficiency in a crowded sightseeing area cause dissatisfaction and stress, there is a heavy burden of making an optimal sightseeing plan for oneself from a vast amount of sightseeing information, further, on the side of a region or a sightseeing industry, there are excessive congestion and an increase in environmental load due to concentration of tourists in a popular sightseeing area, a stay time of a tourist is short and a contribution to a regional economy is limited, service provision is inefficient due to a lack of sightseeing demand and behavior data of a tourist, furthermore, current sightseeing apps and guidebooks have limits in individual optimization and real-time response, and it is difficult to optimize a dynamic sightseeing experience according to a situation, a preference, a physical condition, a congestion status, and the like of each tourist, and to realize a sustainable sightseeing model by decentralization of sightseeing demand.

### SUMMARY OF THE INVENTION

The present invention is a means that configures a system comprising a biometric data acquisition unit, a movement history management unit, a sightseeing proposal generation unit, a congestion prediction unit, and a personalized service provision unit of a tourist, acquires biometric data such as a heart rate, a galvanic skin response, a step count, and position information of the tourist in real time from a wearable device, a smartphone, or the like in the biometric data acquisition unit, records and manages past and present sightseeing spot visit histories and movement routes for each tourist in chronological order in the movement history management unit, analyzes the acquired biometric data and movement history using generative AI and dynamically and individually generates an optimal sightseeing route, a means of transportation, a rest spot, a drop-in destination, and the like based on a fatigue level, a stress value, an interest tendency, a current location, a past behavior pattern, and the like of the tourist in the sightseeing proposal generation unit, collects external data such as real-time congestion degree data for each local sightseeing spot, a past congestion tendency, event information, weather, and traffic conditions, predicts a future congestion degree by a simulation using the generative AI, and reflects the predicted future congestion degree in the sightseeing proposal generation unit to achieve decentralization of sightseeing demand in the congestion prediction unit, and automatically generates and provides to the tourist a service such as an individually optimized coupon, event guidance, and accommodation facility guidance using the generative AI based on an attribute, consumer behavior, a stay time, regional economic data, and the like of the tourist in the personalized service provision unit, thereby providing a sightseeing experience optimized individually and in real time according to a situation, a preference, a physical condition, a congestion status, and the like of each tourist, enhancing decentralization of sightseeing demand and a ripple effect on a regional economy, and enabling realization of a sustainable sightseeing model.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

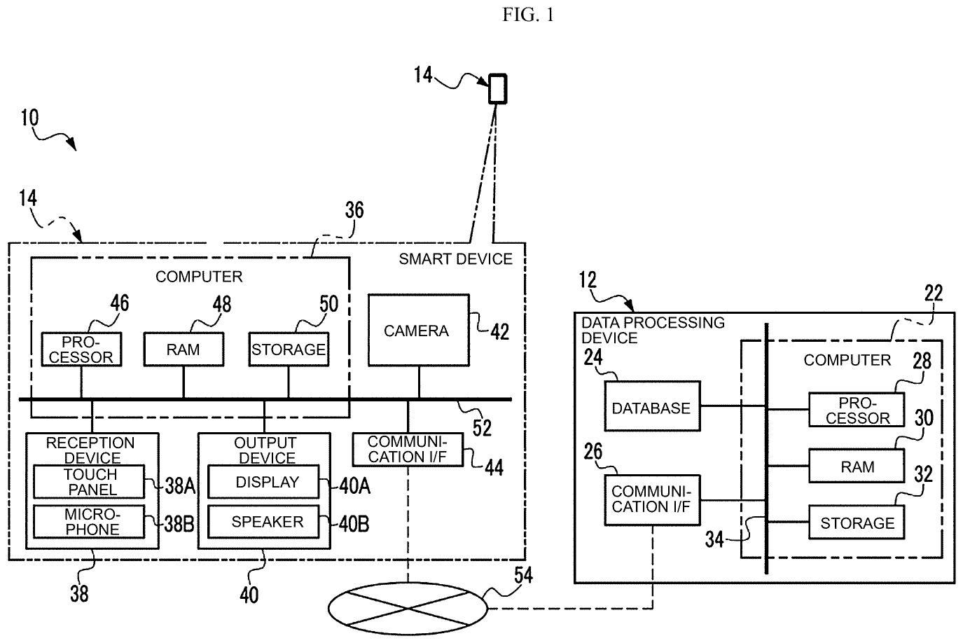

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

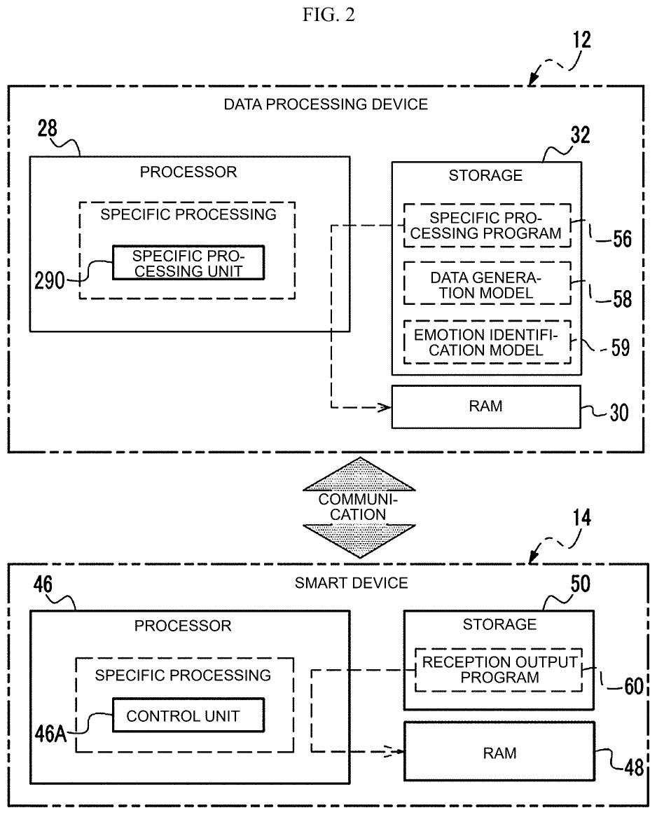

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

An embodiment of the present invention is based on a configuration in which a terminal carried by a tourist and a server installed in a cloud server, a data center, or the like cooperate via a communication network, and utilizes real-time biometric data and a movement history of the tourist to realize optimization of a sightseeing experience, decentralization of sightseeing demand, and maximization of a ripple effect on a regional economy using generative AI. Hereinafter, each component will be described more specifically and in detail. Specifically, the present system causes a plurality of computing nodes to cooperatively operate in a distributed computing environment. The present system constructs a complex AI architecture integrating a large language model and a recurrent neural network for time-series data analysis on the server. The present server receives multidimensional time-series stream data continuously transmitted from the terminal. The present server converts the received stream data into a tensor format in real time. The present server inputs the converted tensor data to the complex AI architecture. The present complex AI architecture extracts a latent pattern in a high-dimensional feature space from the input tensor data. The present complex AI architecture quantifies a behavior intention and a fatigue level of the tourist based on the extracted pattern. The present system dynamically generates an optimal sightseeing route and service content using the quantified index. The present system feeds back the generated information to the terminal. By this processing, the present system significantly reduces a response delay to a dynamic state change of an individual tourist as compared with a conventional static rule-based sightseeing guidance system. The present system dramatically improves calculation efficiency for leveling traffic in an entire sightseeing area. The present system prevents excessive concentration on a specific sightseeing spot. The present system realizes optimal allocation of economic resources in the entire region. The present system is applicable to use cases such as dynamic human flow control in a smart city and real-time crowd guidance in a large-scale event venue.

First, the terminal carried by the tourist includes a smartphone, a tablet terminal, a smartwatch-type or wristband-type wearable device, AR glasses, and the like. For example, the tourist wears a smartwatch-type wearable device on a wrist, and automatically acquires biometric data such as a heart rate, a galvanic skin response, a body temperature, a blood oxygen concentration, a step count, and a sleep state at a high frequency such as every minute or every 10 seconds. Furthermore, a current location, a movement route, a movement speed, a stay time, a drop-in spot, and a means of transportation (walking, bicycle, bus, railway, taxi, etc.) of the tourist are recorded in detail using a GPS function, an acceleration sensor, and a gyro sensor of the smartphone. For example, a detailed history is automatically created such that the tourist arrived at a station at 9:00 a.m., headed for a temple A on foot, arrived at the temple A at 10:00 a.m., stayed for 30 minutes, then moved to a museum C by bus, arrived at 11:00 a.m., and stayed for an hour and a half. Specifically, the present terminal continuously samples analog signals from a plurality of built-in hardware sensors. The present terminal converts the sampled analog signals into digital data via an analog-to-digital conversion circuit. The present terminal applies low-pass filter processing to the converted digital data. The present terminal removes a high-frequency noise component by the low-pass filter processing. The present terminal temporarily stores the data after noise removal in a memory as a multidimensional vector together with a predetermined time stamp. The present terminal structures, for example, the heart rate as an integer value, the galvanic skin response as a floating-point number, and 3-axis acceleration as a three-dimensional vector. The present terminal divides these structured data by a certain window size. The present terminal formats the divided data as a time-series array. The present terminal inputs the formatted time-series array to an edge computing module. The present edge computing module executes initial feature extraction on the input time-series array. The present edge computing module determines a walking state or a stationary state of the tourist from the extracted feature amount. The present terminal dynamically adjusts a positioning frequency of a GPS module based on the determination result. The present terminal sets the positioning frequency high when determining the walking state. The present terminal sets the positioning frequency low when determining the stationary state. By this processing, the present terminal acquires highly accurate movement trajectory data while minimizing battery consumption. The present terminal constructs the acquired movement trajectory data as graph structure data with a spatial index. The present terminal prepares the constructed graph structure data as a payload for transmission to the server. The present system significantly improves power efficiency of a wearable device requiring long-time continuous operation by this dynamic sensor control method. The present system is applicable to use cases such as a distress prevention system for a climber and a monitoring system for an elderly person.

These biometric data and movement history data are uploaded from the terminal to the server in real time or at regular intervals via a communication line such as 4G/5G/Wi-Fi. On the server side, a biometric data acquisition unit receives these data and accumulates them in a database in association with an anonymized ID for each tourist. For example, data such as a heart rate of a tourist X being 90 bpm at 10:00 a.m., a galvanic skin response being a high value, a step count being 5000 steps, a body temperature being 37.2 degrees, and a stress index being high are recorded in chronological order. A movement history management unit records and manages in detail a visited spot, a movement route, a stay time, a means of transportation, a movement distance, the number of drop-ins, a past travel history, and the like for each tourist. For example, a list of all spots visited by a tourist Y in the past week, a stay time at each spot, a selection tendency of a means of transportation, presence or absence of congestion avoidance behavior, and the like are databased. Specifically, the present server processes simultaneous connection requests from a large number of terminals using an asynchronous communication protocol. The present server analyzes header information of a received data packet. The present server specifies authentication information of the terminal and a data format of a payload from the header information. The present server extracts the biometric data and the movement history data included in the payload. The present server applies a hash function to the extracted data. The present server converts personally identifiable information into an irreversible anonymized ID by the hash function. The present server stores the data in a distributed relational database using the anonymized ID as a primary key. The present server indexes the biometric data with millisecond accuracy using a time-series database engine. The present server constructs the movement history data as a spatial index based on a geographic coordinate system using a spatial database engine. The present server periodically applies a clustering algorithm to the accumulated data. The present server extracts a group of tourists having a similar behavior pattern by the clustering algorithm. The present server calculates a statistical feature amount for each extracted group. The present server holds the calculated statistical feature amount in a cache memory. By this processing, the present server significantly reduces a data reading delay during inference processing by a subsequent AI model. The present server improves a response speed of a search query for a large-scale dataset. The present system ensures scalability capable of withstanding simultaneous access on a scale of millions of users by this efficient data management method. The present system is applicable to use cases such as a large-scale logistics tracking system and a fleet management system.

A sightseeing proposal generation unit comprehensively analyzes various data such as biometric data, a movement history, preference data, a current location of a tourist, local sightseeing spot information, congestion prediction data, weather, traffic conditions, event information, and regional characteristics using generative AI. For example, when a fatigue level of a tourist Z is high and there is a tendency to prefer a rest at a cafe or a park in the past, the generative AI preferentially proposes a cafe or a park that is closest to the current location and has a low congestion degree. Furthermore, when the tourist visits many historical buildings, a route incorporating a spot with high historical value as a next destination is automatically generated. For example, a route visiting a temple A, a museum C, and a cafe D in this order is proposed, and an optimal means of transportation (walking, bus, taxi, etc.), a required time, a congestion degree, and a rest timing between the respective spots are also presented together. When the tourist is sightseeing in rainy weather, the generative AI generates a route prioritizing an indoor facility (museum, art museum, shopping mall, etc.), and simultaneously proposes an umbrella rental spot and guidance for an event limited to rainy weather. When the tourist is accompanied by a family, an activity for children, a stroller-compatible route, and position information of a nursing room and a toilet are also included and proposed. In the case of an elderly person, a barrier-free route avoiding stairs and steep slopes, a route with many rest areas, and position information of a medical institution are also presented together. Specifically, the present sightseeing proposal generation unit includes an inference engine based on a large language model. The present sightseeing proposal generation unit acquires, as input data, a numerical vector indicating current biometric data of the tourist, a time-series array indicating a past movement history, and structured text data indicating environmental information. The present sightseeing proposal generation unit acquires, for example, a numerical vector with 10 dimensions including a heart rate and a step count, a time-series array with 50 dimensions including latitudes and longitudes of past visited spots, and structured text data in a JSON format including weather and a congestion degree. The present sightseeing proposal generation unit executes a multimodal encoder for mapping these heterogeneous data to a common latent space. The present multimodal encoder converts the input data into a fixed-length context vector. The present sightseeing proposal generation unit supplies the converted context vector to an input layer of the large language model. The present large language model calculates a dependency relationship between respective elements in the context vector using a self-attention mechanism. The present large language model generates a plurality of optimal sightseeing route candidates based on the calculation result. The present large language model outputs, as output data, structured data including a recommendation score for each route candidate, an order list of spots constituting the route, and a recommended stay time at each spot. The present sightseeing proposal generation unit outputs, for example, structured data of a recommendation score of 0.95 for a route candidate 1, a spot order list, and a recommended stay time of 45 minutes. The present sightseeing proposal generation unit selects a route candidate whose output recommendation score exceeds a predetermined threshold as a final proposal. The present sightseeing proposal generation unit transmits the selected proposal to a user interface unit. By this processing, the present system realizes data-driven highly accurate recommendation that does not depend on human intuition. The present system solves an optimization problem satisfying a complex constraint condition in real time. The present system is applicable to use cases such as an automatic generation system of a personalized learning curriculum and a dynamic supply chain optimization system.

A congestion prediction unit collects various external data such as real-time congestion degree data for each local sightseeing spot, a past congestion tendency, event information, weather, traffic conditions, post data on SNS or the like, operation information of a transportation facility, and movement data of local residents, and executes a simulation by generative AI. For example, using a congestion pattern during a Golden Week period in the past five years, current traffic congestion information, a schedule of a local event, a sudden weather change forecast, a topic on SNS, and the like as input data, the generative AI predicts a congestion degree of each spot several hours later, several days later, and one week later with high accuracy. For example, when a prediction that a temple A will be congested from 2:00 p.m. to 4:00 p.m. is issued, a route visiting in the morning is preferentially generated. Conversely, when a light-up event is held at night, an admission time zone for avoiding congestion and a congestion degree of surrounding restaurants are also predicted, and an optimal visit timing is proposed. Specifically, the present congestion prediction unit constructs a spatiotemporal prediction model combining a graph convolutional network and a long short-term memory network. The present congestion prediction unit generates, as input data, graph structure data having each sightseeing spot as a node and a physical distance and traffic connectivity between spots as an edge. The present congestion prediction unit assigns, to each node, a time-series array indicating a past congestion degree, a categorical variable indicating weather information, and a numerical vector indicating a sentiment analysis score of SNS as a feature amount. The present congestion prediction unit assigns, for example, a time-series array with 24 dimensions including an hourly congestion degree for the past 24 hours, a numerical value indicating a precipitation probability, and a score indicating a positive degree of SNS as a feature amount. The present congestion prediction unit inputs this graph structure data with the feature amount to the spatiotemporal prediction model. The present spatiotemporal prediction model extracts a spatial dependency relationship using a graph convolutional layer. The present spatiotemporal prediction model extracts a temporal dependency relationship using a long short-term memory layer. The present spatiotemporal prediction model predicts a congestion degree of each node at each future time step based on the extracted spatiotemporal feature amount. The present spatiotemporal prediction model outputs, as output data, a probability distribution indicating a future congestion degree of each sightseeing spot and time section data indicating a peak time zone of congestion. The present congestion prediction unit outputs, for example, a probability distribution in which a congestion degree of the temple A at 2:00 p.m. is 80 percent, and time section data indicating that a peak time zone is from 2:00 p.m. to 4:00 p.m. The present congestion prediction unit transmits the output prediction result to the sightseeing proposal generation unit. The present sightseeing proposal generation unit incorporates this prediction result into a route search algorithm as a penalty term. By this processing, the present system predicts not only local congestion but also a dynamic human flow change in the entire region. The present system realizes proactive demand decentralization based on prediction. The present system is applicable to use cases such as a traffic congestion prediction system for urban transportation and a demand prediction system for a power grid.

A personalized service provision unit comprehensively analyzes attribute information (age, gender, nationality, family structure, hobby and preference, etc.) of a tourist, consumer behavior data (past purchase history, coupon use history, use tendency of a restaurant, selection tendency of an accommodation facility, etc.), a stay time, regional economic data, a prediction result of the congestion prediction unit, a current location and a movement schedule of the tourist, and the like, and automatically generates a service optimized for each tourist using generative AI. For example, when the tourist prefers to purchase a local specialty product, a discount coupon for a specialty product store near the current location and limited event guidance are generated and push-notified to the terminal. When the tourist shows a tendency to stay for a long time, discount information of an accommodation facility, guidance for a night event, and information on a restaurant open late at night are automatically generated and distributed. When the tourist shows an interest in a specific event, the generative AI also automatically creates an optimal means of transportation to an event venue, admission guidance by time zone for avoiding congestion, a return route after the event ends, and information on a surrounding rest spot, and notifies the terminal. Furthermore, when the tourist is health-conscious, information on a local organic restaurant and a healthy cafe, a proposal of a walking course and a running course, and health management advice are also provided together. Specifically, the present personalized service provision unit executes a recommendation agent based on a deep reinforcement learning algorithm. The present personalized service provision unit acquires, as input data, a one-hot vector indicating a static attribute of the tourist, a multidimensional sparse tensor indicating past consumer behavior, and a continuous value vector indicating current context information. The present personalized service provision unit acquires, for example, a one-hot vector with 20 dimensions indicating an age group and a nationality, a sparse tensor with 1000 dimensions indicating a category of a past purchased item, and a continuous value vector indicating a latitude and a longitude of the current location. The present personalized service provision unit compresses these input data into a low-dimensional dense state vector using a multilayer perceptron. The present recommendation agent receives this state vector as an observation value from an environment. The present recommendation agent selects an optimal action from a group of providable services using a policy gradient method. The present recommendation agent outputs, as output data, an identifier of a coupon to be provided, a numerical value indicating a discount rate of the coupon, and a time stamp indicating a distribution timing. The present personalized service provision unit outputs, for example, a coupon identifier of a specialty product store, a numerical value indicating a discount rate of 20 percent, and a time stamp indicating 10 minutes after the current time. The present personalized service provision unit generates service information based on the output action. The present personalized service provision unit transmits the generated service information to the terminal via a communication management unit. The present terminal displays the received service information on a screen as a push notification. The present system feeds back a result of whether or not the tourist has used the coupon to the recommendation agent as a reward signal. The present recommendation agent updates a weight parameter of a policy network using the reward signal. By this processing, unlike a static rule-based distribution system, the present system autonomously optimizes a recommendation strategy based on a dynamic reaction of the tourist. The present system realizes efficient allocation of calculation resources for maximizing a conversion rate. The present system is applicable to use cases such as a dynamic pricing system in an e-commerce platform and a real-time bidding system for digital advertising.

On the terminal side, acquisition of biometric data and position information of a tourist, communication with the server, reception and display of a sightseeing proposal and service information generated by generative AI, execution of an AR navigation function, and the like are performed. For example, a sightseeing route and a rest spot proposed by the generative AI are displayed on a map on a screen of a smartphone, and route guidance and spot information are superimposed and displayed in a real space using AR technology. When the tourist accepts the proposal, the selection information is also fed back to the server and utilized as learning data for the generative AI. For example, when the tourist does not select the proposed route, a reason therefor (fatigue, congestion, mismatch of interest, etc.) can be input in a simple questionnaire format, and this is also used for improving personalization accuracy of the generative AI. Specifically, the present terminal inputs a real-time video stream acquired from a built-in camera to an image processing unit. The present image processing unit applies a feature point extraction algorithm to each frame of the video stream. The present image processing unit integrates the extracted feature points and posture data from a built-in sensor using a Kalman filter. The present image processing unit estimates a self-position and a posture of the terminal in a three-dimensional space with high accuracy based on the integrated data. The present terminal analyzes spatial coordinate information included in the sightseeing proposal data received from the server. The present terminal projectively transforms the spatial coordinate information into two-dimensional screen coordinates in a viewing frustum of the camera based on the estimated self-position and posture. The present terminal renders a virtual object at the projectively transformed coordinates. The present terminal superimposes the rendered virtual object on the real video stream using alpha blend processing. The present terminal outputs the superimposed video to a display. The present terminal detects an input operation of the tourist via a touch panel sensor on the display. The present terminal collates coordinate data of the input operation with a bounding box of the displayed virtual object. The present terminal determines a selection behavior of the tourist based on the collation result. The present terminal generates event data indicating the selection behavior. The present terminal asynchronously transmits the event data to the server. The present server accumulates the received event data as teacher data. The present server calculates a loss function of the generative AI using the accumulated teacher data. The present server fine-tunes a parameter of the generative AI using an error backpropagation method. By this processing, the present system provides an advanced user interface that seamlessly integrates a real space and a virtual space. The present system incorporates implicit feedback of a user into a loop of continuous model improvement. The present system is applicable to use cases such as a work support AR system in a factory and a surgery navigation system in a medical field.

In terms of security, quantum cryptography communication technology and privacy-preserving machine learning technology are applied to communication between the terminal and the server, and personal information and a behavior history of a tourist are strictly managed so as not to be leaked to the outside. For example, biometric data of the tourist is managed in association with an anonymized ID, and is configured to be analyzed only on the server. Furthermore, when the tourist desires, a setting in which a part or all of the data is processed only in the terminal and is not transmitted to the server can be selected. Specifically, the present security management unit implements a quantum key distribution protocol in a data transmission path between the terminal and the server. The present security management unit generates an encryption key using a quantum state of a photon. The present security management unit executes encryption and decryption of data by a common key cryptosystem using the generated encryption key. The present security management unit detects a change in the quantum state due to an eavesdropping attempt on a communication path. When detecting eavesdropping, the present security management unit immediately discards a communication session and starts a generation process of a new encryption key. The present system adopts a federated learning architecture in machine learning processing on the server side. The present terminal executes initial model learning on an edge side using locally held biometric data. The present terminal extracts only gradient information of a model updated by learning. The present terminal adds Laplace noise based on differential privacy technology to the extracted gradient information. The present terminal transmits the gradient information to which the noise is added to the server. The present server aggregates gradient information received from a plurality of terminals. The present server updates a parameter of a global model using the aggregated gradient information. The present server redistributes the updated global model to each terminal. By this processing, the present system improves performance of an AI model of the entire system without transmitting raw personal data to the server. The present system optimizes a trade-off between protection of data privacy and accuracy of machine learning. The present system is applicable to use cases such as joint construction of a disease prediction model without sharing patient data among medical institutions and construction of a fraud detection system protecting customer data in a financial institution.

As described above, in the embodiment of the present invention, it is essential that generative AI, as a core of the system, comprehensively analyzes a situation, a preference, a physical condition, a congestion status, regional characteristics, an external environment, and the like of each tourist, and dynamically generates and provides a real-time and individually optimized sightseeing experience and service. For example, it is possible to realize a flexible and highly accurate sightseeing DX platform according to various needs of a tourist, a region, and a tourism industry, such as immediately proposing an optimal rest spot when a fatigue level of the tourist increases, decentralizing sightseeing demand based on congestion prediction, automatically generating an individually optimized coupon and event guidance from consumer behavior data, and providing a detailed service according to various attributes such as a family, an elderly person, a health-conscious person, and a foreign tourist. Furthermore, by the generative AI continuously learning feedback and a behavior history of the tourist, proposal accuracy and service content continue to evolve over time, making it possible to improve tourist satisfaction, maximize a ripple effect on a regional economy, and construct a sustainable sightseeing model. Specifically, the present system includes an orchestration engine that integrates a plurality of independent neural network modules. The present orchestration engine dynamically combines outputs of a biometric data analysis module, a spatial movement prediction module, and a natural language generation module. The present orchestration engine inputs an output tensor from each module to a combination layer. The present combination layer applies non-linear transformation to the combined tensor. The present combination layer generates a high-dimensional integrated feature vector by the non-linear transformation. The present system inputs this integrated feature vector to a final decision-making network. The present decision-making network calculates a probability distribution for a plurality of action candidates using a softmax function. The present system determines an optimal action based on the calculated probability distribution. The present system transmits a control signal for executing the determined action to each subsystem. The present system records an execution result of the action and a reaction of a user as log data. The present system executes an online learning algorithm using the recorded log data. The present online learning algorithm sequentially updates a weight parameter of a model even during system operation. By this processing, the present system adaptively follows a dynamic change in an environment and a transition of a user's preference. The present system provides robust inference even for an unknown situation that cannot be handled by a static system. The present system minimizes latency of the entire system while optimizing consumption of calculation resources. The present system is applicable to use cases such as an integrated control system for an autonomous driving vehicle and a distributed energy management system in a smart grid.

### (System Configuration)

The system according to the present embodiment includes a biometric data acquisition unit, a movement history management unit, a sightseeing proposal generation unit, a congestion prediction unit, a personalized service provision unit, a user interface unit, a communication management unit, and a security management unit.

The biometric data acquisition unit has a function of automatically acquiring biometric data such as a heart rate, a galvanic skin response, a body temperature, a blood oxygen concentration, a step count, a sleep state, and a stress index in real time or at regular intervals from a terminal such as a wearable device or a smartphone worn by a tourist. For example, there is a case where a tourist wears a smartwatch-type device on a wrist, measures a heart rate and a stress index during walking every minute, and transmits data to a smartphone via wireless communication such as Bluetooth or Wi-Fi. In addition, it is also possible to detect an exercise amount and a fall risk of the tourist using an acceleration sensor and a gyro sensor of the smartphone, and to grasp an abnormality in a health condition at an early stage. Furthermore, a current location and a movement route of the tourist can be recorded with high accuracy using a GPS function of the terminal, and a stay time and a change in movement speed in a sightseeing area can also be acquired. In addition, an input interface for the tourist to self-report a physical condition and a mood on the terminal can be provided, and a subjective feeling of fatigue and a stress degree can also be acquired together. Specifically, the biometric data acquisition unit dynamically controls a sampling rate of sensor data in cooperation with a microcontroller unit in the terminal. The biometric data acquisition unit applies a fast Fourier transform to three-axis acceleration vector data acquired from the acceleration sensor. The biometric data acquisition unit calculates a power spectral density in a frequency domain. The biometric data acquisition unit extracts an energy component of a specific frequency band from the calculated power spectral density. The biometric data acquisition unit inputs the extracted energy component to a support vector machine. The support vector machine classifies a current activity state of the tourist into any of walking, running, and resting based on the input energy component. When a classification result is walking or running, the biometric data acquisition unit increases an LED emission frequency of an optical heart rate sensor. When the classification result is resting, the biometric data acquisition unit decreases the LED emission frequency. The biometric data acquisition unit calculates a heart rate variability index from acquired time-series data of the heart rate. The biometric data acquisition unit generates a feature vector by combining the heart rate variability index and an amplitude value of the galvanic skin response. The biometric data acquisition unit inputs the generated feature vector to a random forest classifier. The random forest classifier estimates a stress level as a continuous value from 0 to 100 based on the input feature vector. By this processing, the system maximizes an operating time of the sensor within a limited battery capacity. The system realizes highly accurate estimation of a physiological state from a noisy biometric signal. The system is applicable to use cases such as a continuous monitoring system for a patient in telemedicine and a performance analysis system for a professional athlete.

The movement history management unit has a function of recording and managing a sightseeing spot visit history, a movement route, a stay time, a means of transportation, a movement distance, the number of drop-ins, a past travel history, and the like for each tourist in chronological order. For example, a detailed history such that a tourist arrives at a station at 9:00 a.m., heads to a temple A on foot, arrives at the temple A at 10:00 a.m. and stays for 30 minutes, then moves to a museum C by bus, arrives at 11:00 a.m. and stays for an hour and a half is automatically created. In addition, when the tourist visits the same area a plurality of times, a past visit history and a behavior pattern can be accumulated and utilized for a tendency analysis at the time of a revisit. Furthermore, information on a means of transportation (walking, bicycle, bus, railway, taxi, etc.) used by the tourist and a restaurant or a souvenir shop dropped in during movement is also recorded in detail. In addition, a route selection when the tourist uses AR navigation and a history of changing a route on the way are also managed and utilized for improving proposal accuracy from the next time onward. Specifically, the movement history management unit receives raw GPS coordinate stream data transmitted from the terminal. The movement history management unit applies a Kalman smoothing algorithm to the received coordinate stream data. The movement history management unit corrects a multipath error and a positioning jump by the Kalman smoothing algorithm. The movement history management unit executes a density-based spatial clustering algorithm on the corrected coordinate data group. The movement history management unit extracts a geographical area where the tourist has stayed for a certain period of time or more as a stay point by the spatial clustering algorithm. The movement history management unit collates the extracted stay point with polygon data of a known sightseeing spot using a spatial intersection determination process. The movement history management unit specifies a specific facility visited based on a collation result. The movement history management unit applies a hidden Markov model to a movement segment between stay points. The movement history management unit inputs an average speed of the movement segment, a variance of acceleration, and a curvature of a route as observation variables to the hidden Markov model. The hidden Markov model calculates a probability of a means of transportation based on the input observation variables. The movement history management unit assigns a means of transportation with the highest probability as an attribute of the movement segment. The movement history management unit constructs these processing results on a memory as directed graph structure data composed of nodes and edges. By this processing, the system automatically reconstructs a semantic behavior trajectory from incomplete positioning data. The system compresses a huge amount of position information logs into computationally efficient graph data. The system is applicable to use cases such as a traffic flow survey system in city planning and a contact tracing system for infectious diseases.

The sightseeing proposal generation unit has a function of comprehensively analyzing various data such as biometric data, a movement history, preference data, a current location of a tourist, local sightseeing spot information, congestion prediction data, weather, traffic conditions, event information, and regional characteristics using generative AI, and dynamically generating an optimal sightseeing route, a means of transportation, a rest spot, a drop-in destination, and the like for each tourist. For example, when a fatigue level of the tourist is high and there is a tendency to prefer a rest at a cafe or a park in the past, the generative AI preferentially proposes a cafe or a park that is closest to the current location and has a low congestion degree. In addition, when the tourist visits many historical buildings, a route incorporating a spot with high historical value as a next destination is automatically generated. Furthermore, when the tourist is sightseeing in rainy weather, the generative AI generates a route prioritizing an indoor facility (a museum, an art museum, a shopping mall, etc.), and simultaneously proposes an umbrella rental spot and guidance for an event limited to rainy weather. When the tourist is with a family, an activity for children, a stroller-friendly route, and position information of a nursing room and a toilet are also included and proposed. Specific examples of a prompt sentence to be read by the generative AI include “The current location of the tourist is the museum C, the heart rate is 90 bpm, the stress value is high, and there is a tendency to prefer a rest at a cafe in the past. Propose three rest spots with a low congestion degree within a 10-minute walk from the current location.” and “The tourist is with a family and desires an activity for children. Generate a stroller-friendly sightseeing route around the current location, and propose it including position information of a nursing room and a toilet on the way.” Specifically, the sightseeing proposal generation unit uses a large language model based on a transformer architecture as an inference core. The sightseeing proposal generation unit acquires a structured JSON object including profile information of the tourist, real-time biometric sensor data, and an environmental context as input data. The sightseeing proposal generation unit acquires, for example, profile information including an age and a preference, biometric sensor data including a heart rate and a step count, and an environmental context including weather and a congestion degree. The sightseeing proposal generation unit embeds the acquired JSON object into a natural language prompt template. The sightseeing proposal generation unit generates an input token sequence interpretable by the model by an embedding process. The sightseeing proposal generation unit inputs the generated input token sequence to an encoder layer of the large language model. The large language model calculates a semantic relevance between input tokens using a multi-head attention mechanism. The large language model autoregressively generates a proposal text of an optimal sightseeing route and a rest spot using a decoder layer. The large language model outputs a structured text including a name of a proposed spot, a recommendation reason, and a movement route as output data. The sightseeing proposal generation unit outputs, for example, a specific cafe as a spot name, a text to the effect that it is suitable for fatigue recovery as a recommendation reason, and route information of a 5-minute walk as a movement route. The sightseeing proposal generation unit inputs the output text data to a parser. The parser extracts specific latitude and longitude coordinates and a facility ID from the text data. The sightseeing proposal generation unit generates rendering data for map drawing using the extracted coordinates and ID. By this processing, the system eliminates a rule-based system requiring a complex conditional branch. The system derives an optimal solution that is flexible and in line with a context for various input variables. The system is applicable to use cases such as a dynamic schedule adjustment system in a personal assistant and an automatic response system in customer support.

The congestion prediction unit has a function of collecting various external data such as real-time congestion degree data for each local sightseeing spot, a past congestion tendency, event information, weather, traffic conditions, post data on SNS or the like, operation information of a transportation facility, and movement data of local residents, and executing a simulation by generative AI to predict a future congestion degree with high accuracy. For example, using a congestion pattern during a Golden Week period in the past five years, current traffic congestion information, a schedule of a local event, a sudden change forecast of weather, a topic on SNS, and the like as input data, the generative AI predicts a congestion degree of each spot several hours later, several days later, and one week later. Furthermore, a congestion prediction result is provided to the sightseeing proposal generation unit in real time to achieve decentralization of demand so that a flow line of a tourist does not concentrate on a specific spot. Specific examples of a prompt sentence to be read by the generative AI include “Predict a congestion degree from 10:00 a.m. to 4:00 p.m. tomorrow on an hourly basis based on congestion data during consecutive holidays in the past five years of the temple A, current traffic conditions, the number of SNS posts, and weather information.” Specifically, the congestion prediction unit constructs a time-series data generation model using a generative adversarial network. The congestion prediction unit acquires a multidimensional time-series tensor indicating a past congestion degree and a conditioning vector indicating future event information as input data. The congestion prediction unit acquires, for example, a time-series tensor with 720 dimensions including an hourly congestion degree for the past 30 days, and a conditioning vector with 10 dimensions including tomorrow's weather and an event flag. The congestion prediction unit inputs these input data to a generator network. The generator network generates synthetic time-series data indicating a future congestion degree using a convolutional layer and an upsampling layer. The congestion prediction unit inputs the generated synthetic time-series data and actual observation data to a discriminator network. The discriminator network determines whether the input data is real or synthetic. The congestion prediction unit competitively trains the generator and the discriminator. The congestion prediction unit calculates a future congestion degree prediction value using the trained generator. The congestion prediction unit outputs a congestion degree score in each future time zone of each sightseeing spot and numerical data indicating a confidence interval of prediction as output data. The congestion prediction unit outputs, for example, numerical data indicating a congestion degree score of 85 at 10:00 a.m. of the temple A and a confidence interval of plus or minus 5 percent. The congestion prediction unit writes the output prediction result to a shared memory area. The sightseeing proposal generation unit reads the prediction result from the shared memory area. The sightseeing proposal generation unit uses the prediction result as a weighting parameter of a cost function. By this processing, the system captures a non-linear congestion fluctuation that is difficult to predict by a simple statistical extrapolation method. The system minimizes a prediction error and improves reliability of the entire system. The system is applicable to use cases such as a price fluctuation prediction system in a financial market and an inventory demand prediction system in a supply chain.

The personalized service provision unit has a function of comprehensively analyzing attribute information (age, gender, nationality, family structure, hobby and preference, etc.) of a tourist, consumer behavior data (past purchase history, coupon use history, use tendency of a restaurant, selection tendency of an accommodation facility, etc.), a stay time, regional economic data, a prediction result of the congestion prediction unit, a current location and a movement schedule of the tourist, and the like, and automatically generating a service optimized for each tourist using generative AI. For example, when the tourist prefers to purchase a local specialty product, a discount coupon of a specialty product store near the current location and limited event guidance are generated and push-notified to a terminal. When the tourist shows a tendency to stay for a long time, discount information of an accommodation facility, guidance for a night event, and information on a restaurant open late at night are automatically generated and distributed. When the tourist shows an interest in a specific event, an optimal means of transportation to an event venue, admission guidance by time zone to avoid congestion, a return route after the event ends, and information on a surrounding rest spot are also automatically created by the generative AI and notified to the terminal. Specific examples of a prompt sentence to be read by the generative AI include “The attribute of the tourist is a female in her 30s, health-conscious, and has used an organic restaurant a plurality of times in the past. Generate three discount coupons for a health-conscious restaurant around the current location.” and “The tourist is a foreigner and desires a sightseeing guide service capable of handling English. Propose a guide tour capable of handling English within walking distance from the current location, and also guide a reservation method.” Specifically, the personalized service provision unit executes a hybrid recommendation system combining collaborative filtering and deep learning. The personalized service provision unit acquires an embedding vector including a user ID of the tourist, an item ID, and a context feature amount as input data. The personalized service provision unit acquires, for example, a latent vector with 64 dimensions corresponding to the user ID, a latent vector with 64 dimensions corresponding to the item ID, and a context feature amount indicating a current time and weather. The personalized service provision unit concatenates these vectors in a concatenation layer. The personalized service provision unit inputs the concatenated vector to a multilayer perceptron. The multilayer perceptron performs non-linear feature transformation using a ReLU function as an activation function. The multilayer perceptron predicts a probability that a user clicks a specific service using a sigmoid function in an output layer. The personalized service provision unit outputs a click prediction probability for each service candidate and a personalized message text generated by the generative AI as output data. The personalized service provision unit outputs, for example, a prediction probability of 0.85 for a coupon of a specific restaurant and a message text “Healthy lunch recommended for you”. The personalized service provision unit extracts a service candidate with a high prediction probability. The personalized service provision unit transmits the extracted service candidate to the terminal together with the message text. By this processing, the system extracts a potential interest of the user with high accuracy while mitigating a cold start problem. The system suppresses presentation of irrelevant information and prevents wasteful consumption of a communication band. The system is applicable to use cases such as a content recommendation system in a video distribution platform and a personalized article distribution system in a news application.

The user interface unit receives and displays a sightseeing proposal and service information on a terminal of a tourist, and provides an AR navigation function, a voice guidance function, a push notification function, a feedback input function, and the like. For example, a sightseeing route and a rest spot proposed by generative AI are displayed on a map on a screen of a smartphone, and route guidance and spot information are superimposed and displayed in a real space using AR technology. When the tourist accepts the proposal, the selection information is also fed back to a server and utilized as learning data of the generative AI. When the tourist does not select the proposed route, the reason (fatigue, congestion, mismatch of interest, etc.) can be input in a simple questionnaire format, and this is also used to improve personalization accuracy of the generative AI. Specifically, the user interface unit executes a rendering pipeline of a three-dimensional space using a graphics processing unit of the terminal. The user interface unit applies an edge detection and feature point matching algorithm to an image frame acquired from a camera module. The user interface unit constructs a plane and a depth map of the real space in real time using an output result of the algorithm. The user interface unit arranges polygon data for route guidance received from the server on the constructed depth map. The user interface unit applies a light source calculation and a shading process to the arranged polygon data. The user interface unit writes the processed image to a display buffer. The user interface unit monitors a touch event for a virtual button on the screen. When detecting a touch event, the user interface unit performs an inverse projection transformation on the screen coordinates to perform an intersection determination with an object in the three-dimensional space. The user interface unit acquires an identifier of the object selected by the intersection determination. The user interface unit generates a feedback payload including the acquired identifier. The user interface unit transmits the feedback payload to the server in a background thread. By this processing, the system reliably collects interaction data of a user without hindering a drawing process of a main thread. The system prevents a decrease in a frame rate and provides a smooth user experience. The system is applicable to use cases such as an AR display system of a completed perspective drawing at a construction site and an interactive explanation system of an exhibit in a museum.

The communication management unit controls data transmission and reception between a terminal and a server, and efficiently transmits and receives biometric data, a movement history, a sightseeing proposal, service information, feedback information, and the like in real time or by batch processing using a communication line such as 4G/5G/Wi-Fi. For example, it also has a function of temporarily storing data in the terminal when a communication status is unstable and transmitting the data collectively when communication is restored, and a function of performing data compression and differential transmission to optimize a communication amount. Specifically, the communication management unit constantly monitors a state of a communication session in cooperation with a network interface controller of the terminal. The communication management unit periodically measures a round-trip time and a packet loss rate of a packet. The communication management unit estimates a current network bandwidth based on a measurement result. When the estimated bandwidth falls below a predetermined threshold, the communication management unit applies a lossless compression algorithm combining run-length encoding and Huffman encoding to data scheduled to be transmitted. The communication management unit stores the compressed data in a queuing database constructed in a local non-volatile memory. When detecting that the network bandwidth has recovered, the communication management unit reads the data from the queuing database in a first-in first-out manner. The communication management unit divides the read data into a plurality of small chunks. The communication management unit adds a checksum to each chunk. The communication management unit transmits the chunked data in parallel using a multiplexing technology. The server verifies the checksum of the received chunk. The server restores the original data by combining chunks that have been successfully verified. By this processing, the system completely prevents data loss even in an unstable mobile network environment. The system minimizes wasteful consumption of a network band due to retransmission control. The system is applicable to use cases such as a telemetry data collection system of a drone in a remote location and an operation data synchronization system of a marine vessel.

The security management unit applies a quantum cryptography communication technology and a privacy-preserving machine learning technology to communication between a terminal and a server, and strictly manages personal information and an action history of a tourist so as not to be leaked to the outside. For example, biometric data of the tourist is managed in association with an anonymized ID, and is configured to be analyzed only on the server. When the tourist desires, a setting in which a part or all of the data is processed only in the terminal and is not transmitted to the server can also be selected. Furthermore, a privacy management function capable of finely setting a use range and a storage period of data based on consent of the tourist is also implemented. Specifically, the security management unit secures an independent hardware security module in the terminal. The security management unit generates a pair of a public key and a private key based on an elliptic curve cryptography algorithm in this hardware security module. The security management unit is designed not to export the private key from the hardware security module to the outside at all. Before transmitting confidential data such as biometric data and position information, the security management unit encrypts the data using a common key in the hardware security module. The security management unit encrypts and encapsulates the common key with a public key of the server. The security management unit constructs a transmission payload by combining the encapsulated key and the encrypted data. The server decrypts the common key using its own private key. The server decrypts the data using the decrypted common key. The system applies a homomorphic encryption technology in data processing on the server side. The server directly executes a statistical operation such as addition or multiplication on the data in an encrypted state. The server decrypts and uses only an operation result. By this processing, the system prevents raw personal data from being expanded in plaintext even on a memory of the server. The system fundamentally eliminates vulnerability to an internal crime and a memory dump attack. The system is applicable to use cases such as a secure aggregation system of citizen data in an electronic government and a joint marketing analysis system concealing confidential data among a plurality of companies.

As described above, the system according to the present embodiment includes a multi-layered and advanced function for acquiring and managing real-time biometric data and a movement history of a tourist from multiple angles, individually optimizing a sightseeing experience and a service using generative AI, and realizing congestion prediction, decentralization of demand, and regional economic revitalization, and provides a sightseeing DX platform capable of flexibly responding to various needs of a tourist, a region, and a sightseeing industry. Specifically, the system adopts a distributed processing architecture that hierarchically links an edge device, a fog computing node, and a cloud data center. The system dynamically allocates data filtering, feature extraction, and inference processing in each hierarchy. The system executes high-frequency biometric signal processing and initial abnormality detection in the edge device. The system executes aggregation of a congestion status in a local area and short-term prediction in the fog computing node. The system executes wide-area data integration, complex context understanding using a large language model, and generation of a long-term optimization strategy in the cloud data center. The system links data using an asynchronous messaging queue between these hierarchies. The system constantly monitors a calculation load and a network delay of each node. The system dynamically reconfigures task placement using a container orchestration tool based on a monitoring result. By this processing, the system eliminates a single point of failure and maximizes availability of the entire system. The system enables linear scale-out even for an explosive increase in a data amount and the number of users. The system is applicable to use cases such as an integrated management system of tens of thousands of IoT devices in a smart factory and a real-time evacuation guidance system at the time of a wide-area disaster.

### (Implementation Steps)

Step 1: Acquisition of biometric data and movement history. A tourist carries a terminal such as a wearable device or a smartphone, and biometric data such as a heart rate, a galvanic skin response, a body temperature, a blood oxygen concentration, a step count, a sleep state, and a stress index is automatically acquired in real time or at regular intervals, and in addition, a current location, a movement route, a movement speed, a stay time, a drop-in destination, and a means of transportation (walking, bicycle, bus, railway, taxi, etc.) of the tourist are recorded in detail using a GPS, an acceleration sensor, a gyro sensor, or the like. For example, a detailed history such as the tourist arriving at a station at 9:00 a.m., heading to a temple A on foot, arriving at the temple A at 10:00 a.m. and staying for 30 minutes, then moving to a museum C by bus, arriving at 11:00 a.m. and staying for an hour and a half is automatically created. Specifically, in this step, an operating system of the terminal activates a data collection daemon as a background service. The data collection daemon periodically issues an interrupt request to a device driver of each hardware sensor. The data collection daemon reads raw binary data from a register of the sensor as a response to the interrupt request. The data collection daemon converts the read binary data into a floating-point number. The data collection daemon applies a moving average filter to the converted data to remove sudden noise. The data collection daemon structures the data after noise removal together with a time stamp and a sensor identifier. The data collection daemon inserts the structured data into a local SQLite database. The data collection daemon detects that a file size of the database has reached a predetermined threshold. The data collection daemon generates a data synchronization thread triggered by the detection. The data synchronization thread extracts an untransmitted record from the database. The data synchronization thread serializes the extracted record into a payload in a JSON format. The data synchronization thread transmits the serialized payload to an endpoint of a server as an HTTPS POST request. By this process, the system realizes continuous and stable data collection without depending on a foreground execution state of an application. The system prevents a memory leak and optimizes resource consumption of the terminal. The system is applicable to a use case such as a fatigue level monitoring system for a long-distance truck driver or an ecological survey tracking system for a wild animal.

Step 2: Server transmission and accumulation of data. The acquired biometric data and movement history data are uploaded from the terminal to the server in real time or at regular intervals via a communication line such as 4G/5G/Wi-Fi, and are accumulated in a database in association with an anonymized ID for each tourist by a biometric data acquisition unit and a movement history management unit on the server side. For example, data such as a heart rate of a tourist X being 90 bpm at 10:00 a.m., a galvanic skin response being a high value, a step count being 5000 steps, a body temperature being 37.2 degrees, and a stress index being high are recorded in chronological order. Specifically, the system adopts a lightweight messaging protocol in data communication between the terminal and the server. The system minimizes a communication overhead during data transfer. The biometric data acquisition unit assigns a time stamp in milliseconds to the received data stream. The biometric data acquisition unit stores the data in a distributed time-series database. The biometric data acquisition unit detects data loss due to a communication failure or the like. When detecting the loss, the biometric data acquisition unit automatically complements a missing value using a linear interpolation algorithm. The biometric data acquisition unit applies a digital low-pass filter to remove high-frequency noise derived from a sensor. The movement history management unit constructs a spatial index for the received position information data. The movement history management unit dramatically improves a search speed of geospatial data. The system executes these preprocessings in a distributed manner on an edge side and the server side. The system improves analysis accuracy by a subsequent artificial intelligence model. The system applies a lossless compression algorithm to the accumulated data. The system significantly reduces consumption of a storage capacity. The system efficiently and safely manages tourist data on a scale of millions. The system asynchronously processes writing and reading of data. The system avoids lock contention of the database. The system maintains stable data accumulation performance even under a high-traffic environment. By these technical improvements, the system establishes a real-time data-driven sightseeing support platform.

Step 3: Congestion degree simulation by congestion prediction AI. A congestion prediction unit collects various external data such as real-time congestion degree data for each local sightseeing spot, a past congestion tendency, event information, weather, traffic conditions, post data on SNS or the like, operation information of a transportation facility, and movement data of local residents, and predicts a future congestion degree with high accuracy by generative AI. For example, using a congestion pattern during consecutive holidays in the past five years, current traffic congestion information, a schedule of a local event, a sudden weather change forecast, a topic on SNS, and the like as input data, the generative AI predicts a congestion degree of each spot several hours later, several days later, and one week later. As a specific example of a prompt sentence to be read by the generative AI, “Predict a congestion degree from 10:00 a.m. to 4:00 p.m. tomorrow on an hourly basis based on congestion data of a temple A during consecutive holidays in the past five years, current traffic conditions, the number of SNS posts, and weather information.” is given. Specifically, the congestion prediction unit constructs a transformer-based neural network specialized for time-series data analysis. The congestion prediction unit generates a multidimensional tensor as input data. The congestion prediction unit sets the number of dimensions of the input tensor to three dimensions of time, space, and a feature amount. The congestion prediction unit combines a past congestion degree numerical value, a one-hot vector of a weather category, and a normalized numerical value of the number of social media posts as the feature amount. As a specific example of the input data, the congestion prediction unit inputs an array of the number of visitors per hour for the past 24 hours, a percentage value of a precipitation probability, and an appearance frequency vector of a specific keyword to a model. The congestion prediction unit emphasizes an important time zone or a feature with strong spatial correlation using a self-attention mechanism. The congestion prediction unit generates a congestion probability distribution in each future time zone as output data. As a meaning of an output value, the congestion prediction unit calculates a score indicating a probability that each spot corresponds to a specific congestion level. As a specific example of the output, the congestion prediction unit outputs numerical data that a probability that a congestion level of the temple A at 2:00 p.m. is level 5 is 80 percent, and a probability that the congestion level is level 4 is 15 percent. The congestion prediction unit transmits this output result to a subsequent threshold determination process. When a congestion probability exceeds a predetermined threshold, the system automatically activates a routing process for avoiding the spot. By this process, the system levels congestion in the entire sightseeing area. The system disperses a load on a specific sightseeing resource. The system dynamically changes a spatial resolution of a prediction target in order to efficiently allocate a calculation resource. The system models a non-linear correlation in a high-dimensional space. The system detects early a sudden congestion fluctuation that has been difficult with a conventional rule-based prediction method.

Step 4: Creation of an individually optimized plan by sightseeing proposal generation AI. A sightseeing proposal generation unit comprehensively analyzes various data such as biometric data, a movement history, preference data, a current location of a tourist, local sightseeing spot information, congestion prediction data, weather, traffic conditions, event information, and regional characteristics using generative AI, and dynamically generates an optimal sightseeing route, a means of transportation, a rest spot, a drop-in destination, and the like for each tourist. For example, when a fatigue level of the tourist is high and there is a tendency to prefer a rest at a cafe or a park in the past, the generative AI preferentially proposes a cafe or a park that is closest to the current location and has a low congestion degree. As a specific example of a prompt sentence to be read by the generative AI, “The current location of the tourist is a museum C, a heart rate is 90 bpm, a stress value is high, and there is a tendency to prefer a rest at a cafe in the past. Propose three rest spots with a low congestion degree within a 10-minute walk from the current location.” is given. Specifically, the sightseeing proposal generation unit adopts a composite artificial intelligence architecture combining a large language model and a graph neural network. The sightseeing proposal generation unit constructs a heterogeneous data vector as input data. The sightseeing proposal generation unit includes current location coordinates of the tourist, a normalized numerical value of the heart rate or the stress value, and an embedded representation of a past visit history as elements of the input vector. As a specific example of the input data, the sightseeing proposal generation unit inputs a floating-point array of latitude and longitude, an integer value of a heart rate of 90, and a probability value between zero and one indicating a cafe preference degree to a model. The sightseeing proposal generation unit analyzes a spatial network structure between sightseeing spots using the graph neural network. The sightseeing proposal generation unit generates an optimized node sequence and a recommendation score of each node as output data. As a meaning of an output value, the sightseeing proposal generation unit indicates an order of spots to be visited and a certainty factor of the artificial intelligence for the proposal. As a specific example of the output, the sightseeing proposal generation unit outputs structured data that a first destination is a cafe D with a score of 0.95, and a second destination is a park E with a score of 0.88. The sightseeing proposal generation unit passes this output result to a subsequent route search algorithm. The system executes a unique route search extending Dijkstra's algorithm or an A-star algorithm. The system incorporates not only a movement time but also a fatigue level and a congestion degree into a cost function. By this process, the system minimizes a physical burden on the tourist. The system immediately adapts to a dynamic environmental change. The system provides a personalized sightseeing experience in real time.

Step 5: Service proposal by personalized service generation AI. A personalized service provision unit comprehensively analyzes attribute information (age, gender, nationality, family structure, hobbies and preferences, etc.) of a tourist, consumer behavior data (a past purchase history, a coupon use history, a use tendency of a restaurant, a selection tendency of an accommodation facility, etc.), a stay time, regional economic data, a prediction result of a congestion prediction unit, a current location and a movement schedule of the tourist, and the like, and automatically generates a service optimized for each tourist using generative AI. For example, when the tourist prefers to purchase a local specialty product, a discount coupon for a specialty product shop near the current location or limited event guidance is generated and push-notified to a terminal. As a specific example of a prompt sentence to be read by the generative AI, “An attribute of the tourist is a female in her 30s, health-conscious, and has used an organic restaurant multiple times in the past. Generate three discount coupons for health-conscious restaurants around the current location.” is given. Specifically, the personalized service provision unit constructs a context-aware recommendation system using deep learning. The personalized service provision unit generates a multidimensional context tensor as input data. The personalized service provision unit combines a user feature amount vector, an item feature amount vector, and an environment context vector as elements of the input tensor. As a specific example of the input data, the personalized service provision unit inputs a categorical variable indicating an age group, a logarithmic transformation value of a past purchase amount, and a weather code of the current location to a model. The personalized service provision unit learns a non-linear interaction between feature amounts using a multilayer perceptron. The personalized service provision unit generates a click probability score for each service item as output data. As a meaning of an output value, the personalized service provision unit indicates a high likelihood that the tourist uses a specific coupon or guidance. As a specific example of the output, the personalized service provision unit outputs numerical data that a coupon use probability of an organic restaurant F is 85 percent, and a guidance click probability of a specialty product shop G is 70 percent. The personalized service provision unit transmits this output result to a subsequent push notification control module. The system extracts only an item whose probability score exceeds a predetermined threshold, and optimizes a timing of a notification. The system calculates the current location and a movement speed vector of the tourist. The system fires the notification five minutes before an estimated arrival time at a store. By this process, the system prevents user drop-off due to information overload. The system maximizes a customer referral rate to a local store. The system creates a technical effect of revitalizing a regional economy.

Step 6: Information presentation and feedback acquisition by a user interface. A user interface unit receives and displays a sightseeing proposal and service information on a terminal of a tourist, and provides an AR navigation function, a voice guidance function, a push notification function, a feedback input function, and the like. For example, a sightseeing route and a rest spot proposed by generative AI are displayed on a map on a screen of a smartphone, and route guidance and spot information are superimposed and displayed in a real space using AR technology. When the tourist accepts the proposal, the selection information is also fed back to a server and utilized as learning data for the generative AI. When the tourist does not select the proposed route, a reason (fatigue, congestion, mismatch of interests, etc.) can be input in a simple questionnaire format, which is also used to improve personalization accuracy of the generative AI. Specifically, the user interface unit integrates a camera image of the terminal and data of an inertial measurement unit. The user interface unit executes an algorithm that simultaneously performs self-position estimation and environmental map creation. The user interface unit calculates a rendering position of a virtual object in a three-dimensional spatial coordinate system. The user interface unit superimposes and draws a guidance arrow and store information on a real landscape without delay. The user interface unit records an operation log such as a screen tap or a swipe by the tourist in milliseconds. The user interface unit encodes behavior data of acceptance or rejection of the proposal as a binary vector. The user interface unit inputs a questionnaire result to a natural language processing model and extracts a sentiment polarity score. The system incorporates these feedback data into a reward function of a reinforcement learning model. The system gives a positive reward when the proposal is accepted, and gives a negative reward when the proposal is rejected. The system dynamically updates a weight parameter of an artificial intelligence model using a policy gradient method. By this online learning pipeline, the system continuously improves inference accuracy of the model. The system quickly follows a potential preference change of a user. The system speeds up a drawing process by utilizing a parallel computing capability of a graphical processing unit. The system provides a highly immersive navigation experience while suppressing battery consumption of the terminal.

Step 7: Security management and privacy protection. A security management unit applies a quantum encryption communication technology and a privacy-preserving machine learning technology to communication between a terminal and a server, and strictly manages personal information and a behavior history of a tourist so as not to be leaked to the outside. For example, biometric data of the tourist is managed in association with an anonymized ID, and is configured to be analyzed only on the server. When the tourist desires, a setting in which a part or all of the data is processed only in the terminal and is not transmitted to the server can also be selected. Specifically, the security management unit implements a post-quantum cryptography algorithm based on a lattice-based cryptography scheme. The security management unit mathematically invalidates interception by a third party in a key exchange process. The security management unit adopts a federated learning architecture. The security management unit executes a gradient calculation of an artificial intelligence model in a local environment while keeping the biometric data and position information in the terminal. The security management unit encrypts only the calculated gradient data and transmits it to a central server. The security management unit aggregates gradient data from a plurality of terminals in an encrypted state using a secure multi-party computation technology. The security management unit updates a weight parameter of a global model using the aggregated gradient. By this process, the system completely eliminates transmission of raw data to the server. The system achieves both privacy protection and high accuracy of the model. The system applies quantization and pruning technologies of the model in order to reduce a data processing load on the terminal side. The system enables high-speed inference and learning even with a limited calculation resource of an edge device. The system manages a data retention period and an access authority by a smart contract on a blockchain. The system ensures transparency and tamper resistance of data access. By these advanced security technologies, the system gains user trust and realizes safe operation of the system.

### (Specific Use Case)

For example, when a tourist visits a sightseeing area in a local city, the tourist carries a smartwatch-type wearable device and a smartphone, and is configured to continuously acquire biometric data such as a heart rate, a galvanic skin response, a step count, a body temperature, a blood oxygen concentration, and a stress index in real time from a start of sightseeing. When the tourist arrives at a station and visits a plurality of sightseeing spots such as a temple, a park, and a museum on foot, a current location, a movement route, a movement speed, a stay time at each spot, and a means of transportation (walking, bus, taxi, etc.) are recorded in detail by a GPS and an acceleration sensor of a terminal. A series of behavior histories such as the tourist visiting the temple in the morning, staying for 30 minutes, then moving to the park on foot, and further heading to the museum is automatically transmitted to a server. A biometric data acquisition unit and a movement history management unit accumulate these data in a database in association with an anonymized ID for each tourist, and manage a transition of a fatigue level and a stress value, a movement pattern, a past visit history, and the like of the tourist in chronological order. Specifically, the biometric data acquisition unit acquires an analog signal at a high sampling rate of several tens of hertz from an optical heart rate sensor or a galvanic skin response sensor built in the wearable device. The biometric data acquisition unit converts the analog signal into digital data, and removes body movement noise using a Kalman filter. The biometric data acquisition unit analyzes a frequency component of heart rate variability from the data after noise removal. The biometric data acquisition unit quantifies an activity balance between a sympathetic nerve and a parasympathetic nerve, and calculates the stress index. The movement history management unit integrates a signal of a global positioning system and three-axis data of the acceleration sensor by a sensor fusion technology. The movement history management unit realizes highly accurate position estimation even in an environment where a signal is hard to reach, such as a group of buildings in an urban area. The movement history management unit inputs a variance of a movement speed and a frequency characteristic of acceleration to a machine learning model. The movement history management unit automatically classifies whether the means of transportation of the tourist is walking or a vehicle. The system primarily processes these processes on an edge device side. The system transmits only extracted feature amount data to the server. The system significantly reduces consumption of a communication band. The system combines the biometric data and the position information on the same timeline in the database on the server side. The system constructs a multidimensional data cube having a spatial and temporal context. By this data structure, the system speeds up complex pattern recognition by subsequent artificial intelligence.

The sightseeing proposal generation unit comprehensively analyzes various data such as biometric data, a movement history, preference data, a current location of a tourist, local sightseeing spot information, congestion prediction data, weather, traffic conditions, event information, and regional characteristics using generative AI, and dynamically generates an optimal sightseeing route, a means of transportation, a rest spot, a drop-in destination, and the like for each tourist. For example, when a heart rate of the tourist increases and a stress index is high, the generative AI preferentially proposes a cafe or a park that is most accessible from the current location and has a low congestion degree. When the tourist visits many historical buildings, a route incorporating a spot with high historical value as a next destination is automatically generated. When the tourist is sightseeing in rainy weather, the generative AI generates a route prioritizing an indoor facility (an art museum, a museum, a shopping mall, or the like), and simultaneously proposes an umbrella rental spot and guidance for an event limited to rainy weather. When the tourist is accompanied by a family, an activity for children, a stroller-friendly route, and position information of a nursing room and a restroom are also included and proposed. Specific examples of a prompt sentence to be read by the generative AI include “The current location of the tourist is an art museum, the heart rate is 95 bpm, the stress value is high, and there is a tendency to prefer a rest at a cafe in the past. Propose three rest spots that are within a 10-minute walk from the current location and have a low congestion degree.” and “The tourist is accompanied by a family and desires an activity for children. Generate a stroller-friendly sightseeing route around the current location, and propose the route including position information of a nursing room and a restroom on the way.” Specifically, the sightseeing proposal generation unit deploys a large language model corresponding to a multimodal input on a server. The sightseeing proposal generation unit generates a tensor in which a text prompt and a numerical vector of environmental data are combined as input data. The sightseeing proposal generation unit includes a time-series array of a heart rate, a latitude and a longitude of a current location, and precipitation data acquired from a weather API as elements of the input tensor. The sightseeing proposal generation unit inputs data such as an average heart rate value of 95 for the past 10 minutes, a precipitation of 5 millimeters, and a family composition flag being on to the model as a specific example of the input data. The sightseeing proposal generation unit maps these heterogeneous data to a common latent space using an encoder layer of a transformer architecture. The sightseeing proposal generation unit generates structured routing data as output data. The sightseeing proposal generation unit indicates a coordinate list of waypoints to be passed through and a recommended action at each point as a meaning of an output value. The sightseeing proposal generation unit outputs an ordered list in which a waypoint 1 is an indoor cafe, a waypoint 2 is a nursing room, and a waypoint 3 is an art museum as a specific example of the output. The sightseeing proposal generation unit passes this output result to a subsequent map drawing application programming interface. The system refers to elevation data and step information on the proposed route. The system executes a filtering process for verifying a movement possibility with a stroller. The system provides a safe route considering a physical movement constraint by this process. The system improves satisfaction of the tourist and prevents a trouble due to inappropriate guidance.

The congestion prediction unit collects various external data such as real-time congestion degree data for each local sightseeing spot, a past congestion tendency, event information, weather, traffic conditions, post data on SNS or the like, operation information of a transportation facility, and movement data of local residents, and executes a simulation by generative AI to predict a future congestion degree with high accuracy. For example, using a congestion pattern during consecutive holidays in the past five years, current traffic congestion information, a schedule of a regional event, a sudden change forecast of weather, a topic on SNS, and the like as input data, the generative AI predicts a congestion degree of each spot after several hours, after several days, and after one week. A specific example of a prompt sentence to be read by the generative AI includes “Predict a congestion degree from 10:00 a.m. to 4:00 p.m. tomorrow in units of one hour based on congestion data of a temple during consecutive holidays in the past five years, current traffic conditions, the number of SNS posts, and weather information.” Specifically, the congestion prediction unit constructs a spatiotemporal graph convolutional network that simultaneously learns a spatial dependency and a temporal dependency. The congestion prediction unit generates spatial graph structure data modeling the entire sightseeing area as input data. The congestion prediction unit defines a three-dimensional tensor of the number of nodes, the number of time steps, and the number of feature amounts as a dimension of the input data. The congestion prediction unit allocates the current number of staying persons at each spot, an average vehicle speed on a surrounding road, and a sentiment score of social media as a node feature amount. The congestion prediction unit inputs numerical values such as the number of staying persons at a node A being 500, a vehicle speed being 10 kilometers per hour, and a positive emotion score being 0.8 to the model as a specific example of the input data. The congestion prediction unit calculates a congestion ripple effect between adjacent spots using a graph convolutional layer. The congestion prediction unit generates a future congestion degree prediction value of each node as a continuous value as output data. The congestion prediction unit indicates the expected number of staying persons at each spot in a specific time zone as a meaning of an output value. The congestion prediction unit outputs numerical data such as the expected number of staying persons at the temple at 1:00 p.m. tomorrow being 1200 and an error range being plus or minus 50 persons as a specific example of the output. The congestion prediction unit transmits this output result to a subsequent dynamic weighting process. The system dynamically updates an edge weight of a route search graph based on the predicted congestion degree. The system automatically calculates an alternative route bypassing an area where congestion is expected. The system optimizes traffic of the entire city by this process. The system prevents excessive concentration on a specific sightseeing spot and technically supports sustainable sightseeing spot management.

The personalized service provision unit comprehensively analyzes attribute information (age, gender, nationality, family composition, hobbies and preferences, etc.) of a tourist, consumer behavior data (a past purchase history, a coupon use history, a use tendency of a restaurant, a selection tendency of an accommodation facility, etc.), a stay time, regional economic data, a prediction result of the congestion prediction unit, a current location and a movement schedule of the tourist, and the like, and automatically generates a service optimized for each tourist using generative AI. For example, when the tourist prefers to purchase a local specialty product, a discount coupon for a specialty product store near the current location and limited event guidance are generated and push-notified to a terminal. When the tourist shows a tendency to stay for a long time, discount information of an accommodation facility, guidance for a night event, and information on a restaurant operating late at night are automatically generated and distributed. When the tourist shows an interest in a specific event, an optimal means of transportation to an event venue, admission guidance by time zone for avoiding congestion, a return route after the event ends, and information on a surrounding rest spot are also automatically created by the generative AI and notified to the terminal. Specific examples of a prompt sentence to be read by the generative AI include “The attribute of the tourist is a female in her 30s, health-conscious, and has used an organic restaurant multiple times in the past. Generate three discount coupons for a health-conscious restaurant around the current location.” and “The tourist is a foreigner and desires a sightseeing guide service capable of handling English. Propose a guide tour capable of handling English within walking distance from the current location, and also guide a reservation method.” Specifically, the personalized service provision unit implements a dynamic recommendation algorithm based on deep reinforcement learning. The personalized service provision unit generates a multidimensional tensor in which a state vector of a user and a state vector of an environment are combined as input data. The personalized service provision unit includes an elapsed stay time of the user, a past coupon use rate, and a vacancy status of a store around the current location as elements of the input tensor. The personalized service provision unit inputs numerical values such as a stay time of 360 minutes, a coupon use rate of 60 percent, and the number of vacant stores within a radius of 500 meters being 5 to the model as a specific example of the input data. The personalized service provision unit learns an optimal service provision policy using an actor-critic method. The personalized service provision unit generates a ranking list of providable service items and a provision timing of each item as output data. The personalized service provision unit indicates a combination of services that maximizes satisfaction of the user and a ripple effect on a regional economy as a meaning of an output value. The personalized service provision unit outputs schedule data in which a first place is a 20 percent discount coupon for an accommodation facility distributed at 5:00 p.m., and a second place is guidance for a night light-up event distributed at 6:00 p.m. as a specific example of the output. The personalized service provision unit registers this output result in a subsequent distribution scheduler. The system monitors a current location and a movement vector of the user in real time. The system fires a notification at the moment the user enters a geofence of a target store. The system dramatically improves a conversion rate by this process. The system prevents a decrease in usability due to an irrelevant notification.

A user interface unit receives and displays a sightseeing proposal and service information on a terminal of a tourist, and provides an AR navigation function, a voice guidance function, a push notification function, a feedback input function, and the like. For example, a sightseeing route and a rest spot proposed by generative AI are displayed on a map on a screen of a smartphone, and route guidance and spot information are superimposed and displayed in a real space using AR technology. When the tourist accepts the proposal, the selection information is also fed back to a server and utilized as learning data for the generative AI. When the tourist does not select the proposed route, a reason thereof (fatigue, congestion, mismatch of interests, etc.) can be input in a simple questionnaire format, and this is also used for improving personalization accuracy of the generative AI. Specifically, the user interface unit applies a feature point extraction algorithm to continuous image frames acquired from a camera of the terminal. The user interface unit integrates the extracted feature points and data of a gyro sensor by a Kalman filter. The user interface unit estimates a camera posture with six degrees of freedom in real time. The user interface unit calculates a projection transformation matrix of a three-dimensional virtual object based on the estimated posture matrix. The user interface unit superimposes and draws a virtual guidance line and pop-up information of a store on a real landscape with pixel-level accuracy. The user interface unit collects micro-interaction data such as a line-of-sight movement of a user, a scroll speed of a screen, and a tap position. The user interface unit encodes these operation logs as a time-series vector. The user interface unit converts text data input in a questionnaire into a dense vector using a word embedding model. The system inputs these vector data into a model re-learning pipeline on the server side. The system sequentially updates a weight parameter of an artificial intelligence model using an online gradient descent method. The system proceeds with learning so as to minimize a cross-entropy error between a predicted user behavior and an actual behavior as a loss function. The system adapts the model to a minute preference change of an individual user by this process. The system realizes a technical mechanism that continuously improves recommendation accuracy of the entire system.

As described above, the system of the present invention includes multilayered and advanced functions for multilaterally acquiring and managing real-time biometric data and a movement history of a tourist, individually optimizing a sightseeing experience and a service using generative AI, and realizing congestion prediction, demand decentralization, and regional economic revitalization, and can provide a sightseeing DX platform capable of flexibly responding to various needs of tourists, regions, and the sightseeing industry. Specifically, the system constructs a microservice architecture on a cloud environment. The system deploys each function of biometric data processing, congestion prediction, sightseeing proposal, and service generation as an independent container. The system dynamically scales a computational resource according to a load status of each service using a container orchestration tool. The system maintains latency of the entire system on the order of milliseconds even for a sudden traffic increase at a peak of a sightseeing season. The system adopts an asynchronous message queue for communication between respective modules. The system avoids downtime of the entire system even when a failure occurs in a part of services. The system ensures high availability by a fault-tolerant design. The system optimally distributes a calculation process between an edge device and a cloud server. The system executes an advanced artificial intelligence process in real time while minimizing consumption of a network bandwidth. The system realizes a next-generation sightseeing support infrastructure in which a physical space and a digital space are highly fused, which is not limited to mere information provision, by fundamental improvement of these computer technologies.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

An embodiment of the present invention is an extremely advanced care support system that multilaterally and in real time grasps a health condition and a living situation of a care recipient, an environment inside and outside a facility, an allocation and a working status of a staff, an infectious disease risk, cooperation with a family and a medical staff, and the like in a care facility or a home care site, and simultaneously realizes an individually optimized care proposal, staff allocation optimization, sophistication of facility operation, infectious disease risk dispersion, comfortable environment maintenance, and information sharing with a family and a medical staff with generative AI as a core. Specifically, the system adopts a distributed processing architecture integrating edge computing and cloud computing. The system processes a huge data stream generated from a large number of sensor nodes arranged in a facility in real time. The system executes filtering and primary analysis of data at an edge gateway. The system significantly reduces communication traffic to a cloud server. The system operates a large-scale neural network model on the cloud side. The system executes an advanced calculation for solving an optimization problem of the entire facility. The system fundamentally transforms a conventional care work depending on a human rule of thumb into a data-driven and predictive system by these technical configurations. The system quantitatively reduces a workload of a care staff. The system brings about a clear technical effect of improving safety and quality of life of a care recipient.

A biometric data acquisition unit automatically acquires various biometric data such as a heart rate, a blood pressure, a body temperature, a blood oxygen concentration, a step count, a sleep state, a stress index, a respiratory rate, fall detection, an activity amount, a skin temperature, a sweating amount, a body weight, a meal intake amount, an excretion frequency, a urine volume, a stool property, a swallowing state, a cough and a respiratory sound, facial expression recognition, and a subjective physical condition declaration by voice recognition in real time or at regular intervals from a wearable device, a bed sensor, a clothing built-in sensor, a smartphone, an environmental sensor, or the like worn by a care recipient. For example, the care recipient wears a smartwatch-type device on a wrist, measures a heart rate and a blood pressure every minute, and immediately transmits an alert to a server when an abnormal value is detected. For example, a bed sensor detects a sleep state at night and a timing of getting out of bed and waking up, and evaluates a wandering risk at night and quality of sleep. For example, a clothing built-in sensor constantly monitors a body temperature, a sweating amount, and a skin temperature, and detects a heatstroke risk and a dehydration risk at an early stage. For example, an environmental sensor installed in a toilet or a bathroom detects temperature and humidity and a fall risk, and notifies a staff in case of an abnormality. For example, an IC tag is attached to a meal tray, serving and clearing of a meal are automatically recorded, and a meal intake amount and a meal time are managed. For example, a subjective physical condition, a mood, a complaint of pain, and an anxiety or depression tendency of the care recipient are automatically acquired using voice recognition and facial expression recognition technologies. Specifically, the biometric data acquisition unit synchronizes data streams from heterogeneous sensors on a time axis using a multi-sensor fusion technology. The biometric data acquisition unit absorbs a difference in sampling rate of each sensor by a spline interpolation algorithm. The biometric data acquisition unit generates synchronized multidimensional time-series data. The biometric data acquisition unit executes an isolation forest algorithm on an edge device. The biometric data acquisition unit detects an abnormal value deviating from a distribution of normal biometric data in real time. The biometric data acquisition unit transmits high-resolution raw data to the server only when an abnormality is detected. The system constructs a monitoring system that does not overlook a highly urgent event while saving a network bandwidth by this process. The biometric data acquisition unit extracts a mel-frequency cepstral coefficient for voice data. The biometric data acquisition unit inputs the extracted feature amount to a convolutional neural network to classify an emotion polarity. The biometric data acquisition unit extracts landmark coordinates of a face from a camera image. The biometric data acquisition unit calculates a change vector of a facial expression to quantify a degree of pain. The system stores these objective indicators and subjective indicators in an integrated database. The system forms a high-quality input feature amount space for a subsequent care proposal generation model.

A daily life activity history management unit automatically acquires a daily life activity history such as a meal, excretion, bathing, medication, rehabilitation, recreation, movement, changing clothes, gymnastics, going out, a visit, sleep, awakening, a rest, swallowing training, oral care, nail clipping, a walk, shopping, a hobby activity, a learning activity, television viewing, music appreciation, gardening, pet care, and a video call with a family from a tablet terminal or voice input of a care staff, a sensor device, an IoT home appliance, a smart lock, smart lighting, a smart home appliance, or the like, and records and manages the daily life activity history in chronological order. For example, the care staff inputs an activity such as “8:00 a.m.: breakfast”, “9:00 a.m.: medication”, “10:00 a.m.: rehabilitation”, “11:00 a.m.: excretion”, “1:00 p.m.: lunch”, and “2:00 p.m.: recreation” on a tablet terminal. For example, a medication support robot automatically records a medication time and a medication amount, and prevents forgetting to take medicine and duplicate medication. For example, a rehabilitation device automatically records an exercise content, an exercise amount, and a rehabilitation achievement degree, and utilizes them for individual rehabilitation progress management. For example, an IoT home appliance automatically records a daily life activity such as television viewing, air conditioner operation, turning on/off of lighting, and opening/closing of a curtain, and utilizes it for evaluation of a life rhythm and an independence degree. For example, a smart lock records a history of going out and returning home, and manages a wandering risk and a frequency of going out. For example, a video call with a family and a visit history are recorded, and a status of social interaction is grasped. Specifically, the daily life activity history management unit adopts an event-driven architecture. The daily life activity history management unit receives a state change event from various devices via a publish-subscribe messaging protocol. The daily life activity history management unit applies a natural language processing model to the received event data. The daily life activity history management unit extracts a named entity from voice input or free description text of a staff. The daily life activity history management unit converts the extracted information into structured triple data of “who”, “when”, “where”, and “what was done”. The daily life activity history management unit stores these structured data in a graph database. The daily life activity history management unit connects an action node, a time node, and a place node of the care recipient with an edge. The daily life activity history management unit speeds up a search for a specific behavior pattern and extraction of a correlation by this graph structure. The daily life activity history management unit analyzes a power consumption waveform of a smart home appliance. The daily life activity history management unit automatically identifies which home appliance was used and when using a non-intrusive load monitoring algorithm. The system digitizes a life rhythm of the care recipient with high accuracy without human awareness by these processes. The system saves time and effort for data input, and completely eliminates a missing record and a human error.

A care proposal generation unit comprehensively analyzes biometric data, a daily life activity history, a past behavior pattern, a health condition, a psychological state, and a life rhythm of a care recipient, a congestion status in a facility, weather, infectious disease epidemic information, a request from a family, an instruction from a doctor, a care plan document, a dietary restriction, allergy information, a rehabilitation goal, a dementia progression degree, a fall risk evaluation, a bedsore risk evaluation, a swallowing risk evaluation, medication management, a sleep disorder, a depression tendency, a social isolation risk, a seasonal disease risk, a disaster response plan, and the like using generative AI, and dynamically generates an optimal care plan, a timing of a rest, rehabilitation, and recreation, an optimal timing of a meal, bathing, and medication, personalized communication, an exercise and meal proposal, dementia care, a fall prevention program, swallowing training, oral care, social interaction promotion, a hobby activity proposal, life rhythm adjustment, sleep improvement, stress relief, seasonal disease prevention, disaster evacuation support, and the like for each care recipient. For example, when a heart rate or a body temperature exceeds a predetermined threshold, a “check by a medical staff” or a “rest” is immediately proposed, and when a blood pressure is decreasing, “hydration” or a “rest” is recommended. For example, for a care recipient who has performed rehabilitation in the morning, recreation or a rest is proposed in the afternoon to optimize a balance between activity and rest. For example, when there is a lack of sleep or frequent awakening at night, an activity amount in the daytime is adjusted to improve sleep at night. For example, during an infectious disease epidemic, the number of people, a place, and a time zone of a group activity are automatically adjusted based on a congestion status and zoning information in the facility to minimize an infection risk. For example, when a dementia progression degree or a depression tendency is high, social interaction, a hobby activity, music therapy, reminiscence therapy, pet therapy, or the like is proposed to strengthen psychological care. For example, when a fall risk is high, walking training, a proposal of a barrier-free environment, strengthening of watching over, fall prevention gymnastics, and the like are incorporated. For example, when a swallowing risk is high, swallowing training, adjustment of a meal form, and strengthening of oral care are proposed. Specifically, the care proposal generation unit constructs a hybrid inference engine integrating a transformer-based large language model and a rule-based expert system. The care proposal generation unit generates a tensor in which a numerical vector of biometric data and an embedding vector of history text are combined as input data. The care proposal generation unit sets a dimension of the input tensor to three dimensions of a care recipient feature amount, an environmental feature amount, and a medical constraint feature amount. The care proposal generation unit inputs data such as a systolic blood pressure of 90, a sleep time of 4 hours, and a high fall risk score to the model as a specific example of the input data. The care proposal generation unit calculates a relevance between current biometric data and a past medical history using a self-attention mechanism. The care proposal generation unit generates a probability distribution of a recommended care action and specific instruction text as output data. The care proposal generation unit indicates a probability that each care action is optimal in a current situation as a meaning of an output value. The care proposal generation unit outputs numerical data such as a recommendation probability of hydration being 95 percent and a proposal probability of movement in a wheelchair being 80 percent, and text “Immediately hydrate due to a decrease in blood pressure, and use a wheelchair when moving” as a specific example of the output. The care proposal generation unit transmits this output result to a subsequent task assignment module. The system push-notifies the generated care task to a terminal of a staff. The system tracks an execution status of the task in real time. The system eliminates a variation in care quality due to a personal judgment by this process. The system technically ensures a scientific care practice based on evidence.

A staff allocation optimization unit comprehensively analyzes a current location, a working status, a specialized skill, an assignment history, shift information, qualification information, and years of experience of a staff, a congestion degree in a facility, a health condition and an activity history of a care recipient, an infectious disease risk dispersion status, an emergency response history, a fatigue level and a stress index of a staff, a desired shift of a staff, compatibility between staffs, a cooperation status with a family and a medical staff, and the like, and automatically generates in real time an optimal patrol route, an assignment, a shift adjustment, a response priority in an emergency, workload dispersion, an education and training plan, a rest timing, infectious disease zoning, a disaster response, and the like for each staff using generative AI. For example, when a plurality of specialized rehabilitation staffs are enrolled, an assignment and a patrol order of each staff are optimized based on the number of persons desiring rehabilitation, a health condition, and a congestion degree of a rehabilitation room. For example, in a nighttime zone, a staff who preferentially patrols a living room of a care recipient with a high fall risk is automatically assigned. For example, during an infectious disease epidemic, a flow line and an assigned area of a staff are zoned to reduce a cross-infection risk. For example, in case of a sudden change, an emergency response is assigned to a nearest available staff, and other staffs are made to continue a normal work. For example, when a fatigue level or a stress index of a staff is high, a rest or workload reduction is automatically proposed to prevent burnout. For example, team formation and an assignment are optimized based on compatibility between staffs and a communication history. Specifically, the staff allocation optimization unit solves a dynamic resource allocation problem using a deep reinforcement learning model. The staff allocation optimization unit generates a state vector of the entire facility as input data. The staff allocation optimization unit includes current location coordinates of each staff, a length of a task queue, an urgency score of each task, and a fatigue level index of a staff as elements of the state vector. The staff allocation optimization unit inputs numerical values such as coordinates XY of a staff A, the number of unprocessed tasks being 3, an urgency level being 5, and a fatigue level score being 70 to the model as a specific example of the input data. The staff allocation optimization unit calculates an action value function that maximizes a future reward based on a Markov decision process. The staff allocation optimization unit generates an optimal assignment matrix of a staff and a task as output data. The staff allocation optimization unit outputs a binary matrix indicating which staff should execute which task in which order as a meaning of an output value. The staff allocation optimization unit outputs structured data in which the staff A is assigned to an emergency response in a living room 101 and a staff B is assigned to serving in a dining room as a specific example of the output. The staff allocation optimization unit transmits this output result to a subsequent shift management database and a wearable terminal of each staff. The system minimizes a sum of movement distances of staffs. The system dramatically shortens a waiting time of a task. The system levels a fatigue level of a staff and improves a working environment. The system realizes a technical effect of providing maximum care quality with limited human resources by these processes.

A facility status management unit grasps a congestion degree, a use status, a cleaning and disinfection status, an infectious disease risk dispersion status, a ventilation state, temperature and humidity, an illuminance, a noise level, an operation status of equipment, an evacuation route in a disaster, an opening and closing status of an emergency exit, stockpile management, power consumption, a water supply and drainage status, an operation status of an air conditioning facility, an operation status of an IoT home appliance, and the like of each room and equipment in a facility in real time, and provides information to a care proposal generation unit and a staff allocation optimization unit. For example, the facility status management unit automatically detects a congestion degree of a rehabilitation room, a dining room, a bathroom, a toilet, a recreation room, or the like with a sensor or a camera, and adjusts a use time or the number of people when congestion is expected. For example, the facility status management unit restricts entry to a room where cleaning and disinfection have not been performed, and makes the room available after the cleaning is completed. For example, when insufficient ventilation or high temperature and high humidity is detected, the facility status management unit automatically controls the air conditioning facility or a ventilation fan to maintain a comfortable environment. For example, when the noise level is high, the facility status management unit assigns a living room of a care recipient who needs a rest to another floor. For example, in a disaster, the facility status management unit automatically manages the evacuation route, the opening and closing status of the emergency exit, a remaining amount of a stockpile, and an assignment of an evacuation guidance staff to realize prompt evacuation support. Specifically, the facility status management unit reproduces a physical facility environment in a virtual space in real time using a digital twin technology. The facility status management unit divides a three-dimensional space in the facility into a voxel grid. The facility status management unit maps an environmental parameter such as a temperature, a humidity, a carbon dioxide concentration, and an illuminance to each voxel. The facility status management unit executes a fluid dynamics simulation to identify an air stagnation area. The facility status management unit detects a voxel in which the carbon dioxide concentration exceeds a predetermined threshold. The facility status management unit automatically transmits an operation command to a control application programming interface of the air conditioning facility and the ventilation fan in the corresponding area. The facility status management unit extracts a bounding box of a person from a camera image. The facility status management unit calculates a person density in the space to quantify the congestion degree. When the congestion degree exceeds a threshold, the facility status management unit controls an electronic lock of a smart door to execute a temporary entry restriction. The system autonomously maintains the facility environment in an optimal state at all times by these processes. The system physically and systematically reduces a cluster occurrence risk of an infectious disease. The system optimizes energy consumption efficiency and reduces a running cost of facility operation.

Furthermore, in the present embodiment, generative AI continuously learns feedback from the care recipient, a family, and the staff, and daily operation data, and improves optimization accuracy of a care proposal, a staff allocation, and the facility operation over time. For example, when the care recipient does not select the proposed rehabilitation or recreation, a reason (poor physical condition, mood, congestion, mismatch of interest, or the like) is input in a simple questionnaire format, and is utilized to improve proposal accuracy from the next time onward. For example, feedback regarding a work burden, a shift request, and work efficiency of the staff is collected and reflected in a staff allocation optimization algorithm. For example, a request from the family or an instruction content of a doctor is reflected in the system and automatically incorporated into an individual care plan. For example, a life rhythm and a preference of the care recipient, a physical condition change for each season, a status of social interaction, a response history in a disaster, and the like are learned over a long period of time to predict a future health risk and a life support need. Specifically, the system constructs a continuous integration pipeline implementing an online learning algorithm. The system generates a pair of a proposal content output by the system in the past and an actual behavior result of a user in response thereto as input data. As a specific example of the input data, the system inputs an identifier of a proposed rehabilitation menu, a binary flag indicating whether or not the rehabilitation menu has been executed, and a text vector of a rejection reason to a model. The system defines a composite index of a prediction error and user satisfaction as a loss function. The system updates a weight parameter of a neural network by a daily batch process using a stochastic gradient descent method. The system generates an updated weight file and bias term of the model as output data. The system indicates a highly accurate inference capability reflecting the latest feedback as a meaning of an output value. As a specific example of an output, the system outputs a group of millions of floating-point parameters. The system hot-deploys this output result to an inference server. The system switches a version of the model without downtime of the system. By this process, the system adapts the model to a state of the care recipient and a skill level of the staff that change over time. The system prevents performance degradation of the model due to a change in data distribution called concept drift. The system maintains an artificial intelligence system optimized for the latest situation at all times.

In addition, as security management, a quantum cryptography communication technology or a privacy-preserving machine learning technology is applied to communication between a terminal and a server to strictly manage personal information, health data, and a behavior history of the care recipient so as not to be leaked to the outside. For example, biometric data of the care recipient is managed in association with an anonymized ID, and is configured to be analyzed only on the server. For example, when the care recipient or the family desires, a setting in which a part or all of the data is processed only in the terminal and is not transmitted to the server can be selected. For example, a privacy management function capable of finely setting a use range and a storage period of data, presence or absence of provision to a third party, anonymization of feedback, and the like is implemented. Specifically, a security management unit incorporates a post-quantum cryptography algorithm based on a lattice cryptography method into a communication protocol. The security management unit mathematically guarantees confidentiality of data even against a decryption attack by a future quantum computer. The security management unit applies homomorphic encryption, which is a type of secure computation technology. The security management unit executes an arithmetic process such as addition or multiplication on the server while keeping the biometric data and history data of the care recipient encrypted. The security management unit maintains a state in which even an administrator of the server cannot browse the content of raw data at all. The security management unit returns only an arithmetic result to a terminal having a decryption authority. The system fundamentally eliminates a data leakage risk in a cloud environment by this process. The system applies a local differential privacy technology on the terminal side. The system intentionally adds statistical noise to data before transmission. The system maintains a tendency of a macro data distribution while making it impossible to identify an individual. The system achieves both advanced privacy protection and learning efficiency of a machine learning model. The system fully complies with strict data protection regulations in a medical and nursing care field by these technical means. The system provides a safe and highly reliable system infrastructure.

As described above, the embodiment of the present invention is an extremely comprehensive and advanced care support system that acquires and manages the biometric data and daily life activity history of the care recipient and various information inside and outside the facility in real time and from multiple angles, and simultaneously realizes an individually optimized care proposal, staff allocation optimization, sophistication of facility operation, infectious disease risk dispersion, comfortable environment maintenance, strengthening of cooperation with a family and a medical professional, a response in a disaster, long-term health risk prediction, and the like with the generative AI as a core. Specifically, the system causes a plurality of calculation nodes to cooperatively operate in a distributed computing environment. The system constructs a composite AI architecture integrating a large language model and a recurrent neural network for time-series data analysis on the server. The system receives the biometric data and environmental data of the care recipient as a multidimensional time-series tensor as input data. The system executes a preprocessing of normalization and missing value completion on the input data. The system inputs the preprocessed tensor to the composite AI architecture. The system calculates a hidden correlation between respective data using a self-attention mechanism inside the composite AI architecture. The system outputs a transition probability distribution of a future health condition based on a calculation result. The system inputs the output probability distribution to a subsequent optimization algorithm. The system calculates an optimal solution of a staff allocation matrix and a care schedule using the optimization algorithm. The system distributes the calculated optimal solution to each terminal. The system executes these processes with a low latency in milliseconds. The system converts a conventional care work that has relied on a human rule of thumb into a data-driven precise control process. The system thereby dramatically improves operation efficiency of the entire facility. The system simultaneously creates a technical effect of reducing a health risk of the care recipient in advance. The system is applicable to various care sites such as a large-scale special nursing home for the elderly and a wide-area home-visit care network.

### (System Configuration)

The system according to the present embodiment includes a biometric data acquisition unit, a daily life activity history management unit, a care proposal generation unit, a staff allocation optimization unit, a facility status management unit, a user interface unit, a communication management unit, and a security management unit.

The biometric data acquisition unit is a unit configured to automatically acquire various biometric data such as a heart rate, a blood pressure, a body temperature, a blood oxygen concentration, a step count, a sleep state, a stress index, a respiratory rate, fall detection, an activity amount, a skin temperature, a sweating amount, a body weight, a meal intake amount, an excretion frequency, a urine volume, a stool property, a swallowing state, a cough or a respiratory sound, facial expression recognition, and a subjective physical condition declaration by voice recognition in real time or at regular intervals from a wearable device, a bed sensor, a clothing built-in sensor, a smartphone, an environmental sensor, or the like worn by the care recipient. For example, the care recipient wears a smartwatch-type device on a wrist, measures the heart rate and the blood pressure every minute, and immediately transmits an alert to the server when an abnormal value is detected. For example, the bed sensor detects a nighttime sleep state and a timing of getting out of bed or waking up, and evaluates a nighttime wandering risk and sleep quality. For example, the clothing built-in sensor constantly monitors the body temperature, the sweating amount, and the skin temperature, and detects a heatstroke risk and a dehydration risk at an early stage. For example, the environmental sensor installed in a toilet or a bathroom detects temperature and humidity and a fall risk, and notifies the staff in the event of an abnormality. For example, an IC tag is attached to a meal tray, serving and clearing of a meal are automatically recorded, and the meal intake amount and a meal time are managed. For example, a subjective physical condition, a mood, a complaint of pain, anxiety, and a depressive tendency of the care recipient are automatically acquired using a voice recognition or facial expression recognition technology. Specifically, the biometric data acquisition unit controls a microcontroller and an analog-to-digital conversion circuit incorporated in each sensor device. The biometric data acquisition unit converts an analog biometric signal into digital data at a predetermined sampling rate. The biometric data acquisition unit applies a low-pass filter to the digital data to remove high-frequency noise. The biometric data acquisition unit temporarily stores the data after noise removal in a memory buffer as a one-dimensional time-series vector. The biometric data acquisition unit extracts an R-R interval from electrocardiogram waveform data, for example, and quantifies a stress index indicating an activity state of an autonomic nerve. The biometric data acquisition unit inputs face image data acquired from a camera to a convolutional neural network as a three-dimensional tensor. The biometric data acquisition unit analyzes a movement of a facial muscle using the convolutional neural network. The biometric data acquisition unit outputs a facial expression score indicating pain or anxiety as an analysis result. The biometric data acquisition unit converts voice waveform data acquired from a voice microphone into a mel-frequency cepstral coefficient. The biometric data acquisition unit inputs the converted coefficient to a voice recognition model. The biometric data acquisition unit extracts an utterance content of the care recipient as text data using the voice recognition model. The biometric data acquisition unit packages these various data as structured data together with a time stamp and a device identifier. The biometric data acquisition unit transmits the packaged data to the server using a secure communication protocol. The biometric data acquisition unit thereby continuously supplies high-quality input data for advanced AI analysis on the server side. The biometric data acquisition unit exhibits a technical effect of improving reliability of the entire system by preventing data loss or delay. The biometric data acquisition unit is applied to a wide range of use cases such as remote monitoring in home care and patient management in an acute care hospital.

The daily life activity history management unit is a unit configured to automatically acquire a daily life activity history such as a meal, excretion, bathing, medication, rehabilitation, recreation, movement, changing clothes, gymnastics, going out, a visit, sleep, awakening, a rest, swallowing training, oral care, nail clipping, a walk, shopping, a hobby activity, a learning activity, watching television, listening to music, gardening, pet care, and a video call with a family from a tablet terminal or voice input of a care staff, a sensor device, an IoT home appliance, a smart lock, smart lighting, a smart home appliance, or the like, and record and manage the daily life activity history in chronological order. For example, the care staff inputs an activity such as “8:00 a.m.: breakfast”, “9:00 a.m.: medication”, “10:00 a.m.: rehabilitation”, “11:00 a.m.: excretion”, “1:00 p.m.: lunch”, and “2:00 p.m.: recreation” on the tablet terminal. For example, a medication support robot automatically records a medication time and a medication amount to prevent forgetting to take medicine and duplicate medication. For example, a rehabilitation device automatically records an exercise content, an exercise amount, and a rehabilitation achievement degree, and utilizes them for individual rehabilitation progress management. For example, the IoT home appliance automatically records a daily life activity such as watching television, an air conditioner operation, turning on/off of lighting, and opening/closing of a curtain, and utilizes it for evaluation of a life rhythm and an independence degree. For example, the smart lock records a history of going out and returning home, and manages a wandering risk and a frequency of going out. For example, a video call with the family and a visit history are recorded to grasp a status of social interaction. Specifically, the daily life activity history management unit receives event data asynchronously transmitted from a large number of IoT devices and input terminals of the staff arranged in the facility using a message queuing system. The daily life activity history management unit analyzes the received event data using a natural language processing model. The daily life activity history management unit converts, for example, free-description text data input by the staff into a word embedding vector. The daily life activity history management unit inputs the embedding vector to a classification model to automatically determine an activity category and an emotional polarity. The daily life activity history management unit processes binary data acquired from the smart lock or a human sensor as a time-series on-off signal. The daily life activity history management unit integrates these heterogeneous data to generate a multidimensional state matrix indicating a behavior trajectory for each care recipient. The daily life activity history management unit stores the generated state matrix in a distributed database. The daily life activity history management unit dynamically reconstructs an index of the database to optimize a search speed. The daily life activity history management unit extracts a frequently appearing behavior pattern from past behavior history data using an association analysis. The daily life activity history management unit sets the extracted pattern as a baseline. The daily life activity history management unit compares behavior data input in real time with the baseline. The daily life activity history management unit generates an abnormal behavior flag when a statistical outlier is detected. The daily life activity history management unit immediately transfers the abnormal behavior flag to the subsequent care proposal generation unit. The daily life activity history management unit thereby automates early discovery of wandering of a dementia patient and detection of a disturbance of a life rhythm. The daily life activity history management unit brings about a technical effect of significantly reducing a monitoring burden on a human. The daily life activity history management unit is widely applicable to a watching work in a group home or a housing with services for the elderly.

The care proposal generation unit is a unit configured to comprehensively analyze the biometric data, the daily life activity history, a past behavior pattern, a health condition, a psychological state, and a life rhythm of the care recipient, a congestion status in the facility, weather, infectious disease epidemic information, a request from the family, an instruction of a doctor, a care plan document, a dietary restriction, allergy information, a rehabilitation goal, a dementia progression degree, a fall risk evaluation, a bedsore risk evaluation, a swallowing risk evaluation, medication management, a sleep disorder, a depressive tendency, a social isolation risk, a seasonal disease risk, a response plan in a disaster, and the like using the generative AI, and dynamically generate an optimal care plan, a timing of a rest, rehabilitation, and recreation, an optimal timing of a meal, bathing, and medication, personalized communication, an exercise and meal proposal, dementia care, a fall prevention program, swallowing training, oral care, social interaction promotion, a hobby activity proposal, life rhythm adjustment, sleep improvement, stress relief, seasonal disease prevention, evacuation support in a disaster, and the like for each care recipient. For example, when the heart rate or the body temperature exceeds a predetermined threshold, “check by a medical staff” or “rest” is immediately proposed, and when the blood pressure is decreasing, “hydration” or “rest” is recommended. For example, for a care recipient who has performed rehabilitation in the morning, recreation or a rest is proposed in the afternoon to optimize a balance between activity and rest. For example, when there is a lack of sleep or frequent nighttime awakening, an activity amount in the daytime is adjusted to improve nighttime sleep. For example, during an infectious disease epidemic, the number of people, a place, and a time zone of a group activity are automatically adjusted based on the congestion status and zoning information in the facility to minimize an infection risk. For example, when the dementia progression degree or the depressive tendency is high, social interaction, a hobby activity, music therapy, reminiscence therapy, pet therapy, or the like is proposed to strengthen psychological care. Specific examples of a prompt sentence to be read by the generative AI include “The heart rate of the care recipient is 105, the blood pressure is 110/70, the body temperature is 36.8, and the latest activity is a meal. Propose an activity to be recommended next and a necessary staff response.”, “The sleep time of the care recipient is short, and there is frequent nighttime awakening. Propose daytime activity amount adjustment and a sleep improvement measure.”, and the like. Specifically, the care proposal generation unit deploys a transformer-based large language model having billions of parameters to a GPU cluster on the server. The care proposal generation unit converts the biometric data, the daily life activity history, environmental data, and a medical record into fixed-length latent vectors using respective unique encoders. The care proposal generation unit combines these latent vectors to construct a multimodal input tensor. The care proposal generation unit generates, for example, a 512-dimensional tensor combining a heart rate vector, a blood pressure vector, an activity log vector for the past 24 hours, and a congestion degree vector in the facility as the input tensor. The care proposal generation unit inputs this input tensor to the large language model. The care proposal generation unit calculates a self-attention mechanism inside the large language model to evaluate a complex dependency relationship between respective data elements. The care proposal generation unit outputs a text token sequence indicating a candidate for an action to be taken next and a probability score indicating a recommendation degree of each candidate as an output from the large language model. The care proposal generation unit generates, for example, a numerical group such as a proposal score of 0.85 for hydration, a proposal score of 0.92 for a rest, and a proposal score of 0.12 for rehabilitation as the output. The care proposal generation unit compares the output score group with a predetermined threshold. The care proposal generation unit filters only a proposal exceeding the threshold to construct a final care plan. The care proposal generation unit transmits the constructed care plan to a user interface unit to display the care plan on a screen. The care proposal generation unit receives feedback from the staff as a reward signal using reinforcement learning. The care proposal generation unit continuously fine-tunes a weight of the model based on the reward signal. The care proposal generation unit thereby realizes a technical effect of autonomously improving accuracy of the proposal and adaptability to the site. The care proposal generation unit provides an extremely effective means in a field of personalized medicine and personal healthcare.

The staff allocation optimization unit is a unit configured to comprehensively analyze a current location, a working status, a specialized skill, an assignment history, shift information, qualification information, and years of experience of a staff, a congestion degree in the facility, a health condition and an activity history of the care recipient, an infectious disease risk dispersion status, an emergency response history, a fatigue level and a stress index of the staff, a desired shift of the staff, compatibility between staffs, a cooperation status with a family and a medical professional, and the like, and automatically generate in real time an optimal patrol route, an assignment, a shift adjustment, a response priority in an emergency, work burden dispersion, an education and training plan, a rest timing, infectious disease zoning, a response in a disaster, and the like for each staff using the generative AI. For example, when a plurality of rehabilitation specialized staffs are enrolled, an assignment and a patrol order of each staff are optimized based on the number of people desiring rehabilitation, a health condition, and a congestion degree of a rehabilitation room. For example, in a nighttime zone, a staff who preferentially patrols a living room of a care recipient with a high fall risk is automatically assigned. For example, during an infectious disease epidemic, a flow line and an assigned area of the staff are zoned to reduce a cross-infection risk. For example, in the event of a sudden change, an emergency response is assigned to the nearest available staff, and other staffs are caused to continue a normal work. For example, when the fatigue level or the stress index of the staff is high, a rest or work burden reduction is automatically proposed to prevent burnout. Specific examples of a prompt sentence to be read by the generative AI include “Staff A is available, staff B is busy, and the congestion degree of the rehabilitation room is 1. Propose an optimal assignment of each staff.”, “There are a plurality of care recipients with a high fall risk in the nighttime zone. Propose an optimal assignment of a patrol staff and a patrol order.”, and the like. Specifically, the staff allocation optimization unit models a spatial structure in the facility and a relationship between the staff and the care recipient as graph structure data. The staff allocation optimization unit defines each staff and care recipient as a node, and defines a physical distance and a necessity of a response as a weight of an edge. The staff allocation optimization unit inputs this graph structure data to a graph neural network. The staff allocation optimization unit updates a feature amount of each node using the graph neural network, and generates a state vector expressing a situation of the entire facility. The staff allocation optimization unit inputs the state vector to a deep reinforcement learning agent. The staff allocation optimization unit outputs an optimal staff allocation matrix and patrol route vector using the deep reinforcement learning agent. The staff allocation optimization unit uses, for example, a tensor including a current position coordinate of the staff, an urgency score of the care recipient, and an infection risk value of each room as input data. The staff allocation optimization unit generates a sequence of a room number to be visited next by each staff and an assignment probability distribution of each task as output data. The staff allocation optimization unit inputs the output allocation matrix to a constraint satisfaction solver. The staff allocation optimization unit verifies whether a hard constraint such as the Labor Standards Act or a qualification requirement of the staff is satisfied. When the constraint is not satisfied, the staff allocation optimization unit gives a penalty and executes recalculation. The staff allocation optimization unit push-notifies a finally determined schedule to a mobile terminal of each staff. The staff allocation optimization unit completes this series of processes within a few seconds. The staff allocation optimization unit exhibits a technical effect of reallocating a resource in real time to a dynamically changing site situation. The staff allocation optimization unit is also applicable to nurse allocation in a large-scale hospital, flow line optimization of a picking worker in a logistics warehouse, and the like.

The facility status management unit is a unit configured to grasp a congestion degree, a use status, a cleaning and disinfection status, an infectious disease risk dispersion status, a ventilation state, temperature and humidity, an illuminance, a noise level, an operation status of equipment, an evacuation route in a disaster, an open/closed status of an emergency exit, stockpile management, power consumption, a water supply and drainage status, an operation status of air conditioning equipment, an operation status of an IoT home appliance, and the like of each room and equipment in a facility in real time, and provide information to the care proposal generation unit and the staff allocation optimization unit. For example, the facility status management unit automatically detects a congestion degree of a rehabilitation room, a dining room, a bathroom, a toilet, a recreation room, or the like with a sensor or a camera, and adjusts a use time or the number of people when congestion is predicted. For example, the facility status management unit restricts entry to a room where cleaning and disinfection have not been performed, and makes the room available after the cleaning is completed. For example, when insufficient ventilation or high temperature and high humidity is detected, the facility status management unit automatically controls the air conditioning equipment or a ventilation fan to maintain a comfortable environment. For example, when the noise level is high, the facility status management unit allocates a living room of a care recipient who needs a rest to another floor. For example, in a disaster, the facility status management unit automatically manages the evacuation route, the open/closed status of the emergency exit, a remaining amount of stockpiles, and an assignment of an evacuation guidance staff to realize prompt evacuation support. Specifically, the facility status management unit continuously receives high-resolution RGB image streams from a large number of network cameras installed in the facility. The facility status management unit divides the received image stream in units of frames, and inputs the divided image stream to a convolutional neural network as a three-dimensional image tensor. The facility status management unit detects a person or an object in the image using the convolutional neural network, and outputs coordinates of a bounding box and a class label. The facility status management unit aggregates the number of detected persons to calculate a real-time congestion degree score of each area. The facility status management unit inputs time-series data of temperature, humidity, and a CO2 concentration acquired from an environmental sensor to a long short-term memory network. The facility status management unit predicts an environmental change after several hours using the long short-term memory network, and outputs a predicted value vector. The facility status management unit automatically generates a control command for the air conditioning equipment or a ventilation system when the predicted value vector deviates from a threshold of a comfort standard. The facility status management unit transmits the generated control command to each equipment via an IoT gateway to drive an actuator. For example, when it is predicted that the CO2 concentration exceeds 1000 ppm, the facility status management unit outputs a PWM signal for increasing a rotation speed of the ventilation fan. The facility status management unit maps these environmental data to a database using a spatial index. The facility status management unit responds to a data query from the care proposal generation unit and the staff allocation optimization unit in units of milliseconds. The facility status management unit provides a technical effect of always maintaining a facility environment in an optimal state and mathematically minimizing a cluster occurrence risk of an infectious disease. The facility status management unit also functions as an energy management system of a smart building or a crowd control system of a commercial facility.

A user interface unit is a unit configured to provide a function that enables a care recipient, a staff, a family member, and a medical worker to intuitively operate and browse a care proposal, a facility status, a staff assignment, a feedback input, an emergency response, visualization of a life rhythm, a transition of a health condition, an alert notification, a video call, a chat, a questionnaire, a reminder, schedule management, and the like on a terminal. For example, the care recipient can check a next activity proposal or a graph of the health condition on a tablet terminal. For example, the staff can receive a charge assignment or an emergency alert on a smartphone and respond immediately. For example, the family member can remotely make a video call, check the health condition, and input a request. For example, the medical worker can browse long-term data, a medication history, and a rehabilitation progress of a patient, and input an instruction. Specifically, the user interface unit always connects a front-end web application and a back-end server group using a WebSocket protocol. The user interface unit asynchronously receives update data in a JSON format push-distributed from a server. The user interface unit reflects the received data on a virtual DOM tree, and redraws only a difference of a screen at high speed. The user interface unit smoothly renders a complex transition graph of the health condition or a 3D map in the facility using a GPU of the terminal. The user interface unit captures an event of a touch operation or a scroll operation of a user, and records the event as an operation log vector. The user interface unit inputs a text feedback or an evaluation score input by the user to a natural language processing pipeline. The user interface unit extracts a keyword or an emotion score from text data, and converts the text data into structured data. The user interface unit transmits the converted data to the server, and adds the converted data to a learning data set for fine tuning of the generative AI. For example, when the staff gives a label “inappropriate” to the proposed care plan, the user interface unit uses the context data as an input of an error backpropagation method to correct a weight of a model. Thereby, the user interface unit enables the system to learn an implicit intention of the user or a local rule of a site. The user interface unit brings about a technical effect of smoothing cooperative work between a human and the AI and enhancing acceptability of the system. The user interface unit is widely utilized as an interface of a telemedicine platform or an education support system.

A communication management unit is a unit configured to control data transmission and reception between the terminal and the server, and efficiently transmit and receive the biometric data, the daily life activity history, the care proposal, the staff assignment, the facility status, feedback information, and the like in real time or by batch processing using a communication line such as 4G, 5G, Wi-Fi, or a wired LAN. For example, the communication management unit also includes a function of temporarily storing data in the terminal when a communication status is unstable and collectively transmitting the data when communication is recovered, and a function of performing data compression or difference transmission to optimize a communication traffic. Specifically, the communication management unit implements a machine learning model that constantly monitors a bandwidth and a delay status of a network and predicts a fluctuation in communication quality. The communication management unit inputs history data of a past packet loss rate, a round trip time, and a signal strength to a recurrent neural network as a time-series tensor. The communication management unit predicts an available bandwidth several seconds ahead using the recurrent neural network, and outputs a predicted value. The communication management unit dynamically adjusts a compression rate or a resolution of transmission data based on the predicted bandwidth. For example, when it is predicted that the bandwidth is narrow, the communication management unit inputs image data to an autoencoder, compresses the image data into a low-dimensional latent representation, and then transmits the compressed image data. The communication management unit restores original image data using a decoder on a receiving side. The communication management unit gives a high QoS priority to emergency alert data having high importance, and allocates a dedicated communication channel. The communication management unit buffers background data having low importance in a local storage, and executes batch transmission at a timing when a communication environment is improved. The communication management unit calculates a checksum using a hash function at the time of data transmission and reception, and verifies integrity of the data. When a loss of a packet is detected, the communication management unit reacquires only the lost packet using an automatic repeat request protocol. Thereby, the communication management unit prevents a loss of data even under an unstable mobile network environment. The communication management unit realizes a technical effect of leveling communication traffic and significantly reducing a load on a network interface of the server. The communication management unit is applicable to a telematics system of a connected car or remote control communication of a drone.

A security management unit is a unit configured to apply a quantum cryptography communication technology or a privacy-preserving machine learning technology to communication between the terminal and the server, and strictly manage personal information, health data, and a behavior history of the care recipient so as not to be leaked to the outside. For example, the biometric data of the care recipient is managed in association with an anonymized ID, and is configured to be analyzed only on the server. For example, when the care recipient or the family member desires, a setting in which a part or all of the data is processed only in the terminal and is not transmitted to the server can also be selected. For example, the security management unit implements a privacy management function capable of finely setting a use range and a storage period of data, presence or absence of provision to a third party, anonymization of feedback, and the like. Specifically, the security management unit adopts an architecture of federated learning, and executes learning of a local model on a terminal side without transmitting the biometric data itself to the server. The security management unit extracts only a gradient vector of the model calculated in each terminal. The security management unit applies a homomorphic encryption algorithm to the extracted gradient vector to generate an encrypted numerical vector. The security management unit transmits the encrypted vector to the server. The security management unit adds gradient vectors from a plurality of terminals while keeping an encrypted state on a server side, and calculates a weight update vector of a global model. The security management unit distributes the updated global model to each terminal again. The security management unit exchanges a session key dynamically generated using a public key cryptosystem in all communication sessions between the terminal and the server. The security management unit executes encryption and decryption of a packet by an AES-256 algorithm using the exchanged session key. The security management unit collates a role-based access control list with respect to an access request to a database, and strictly determines presence or absence of an authority. The security management unit records all access histories and data operation histories in a tamper-proof blockchain ledger, and stores them as an audit log. Thereby, the security management unit mathematically prevents data leakage due to an internal crime or a cyberattack from the outside. The security management unit creates a technical effect of achieving both privacy protection and advanced AI analysis. The security management unit becomes an essential fundamental technology in customer data analysis of a financial institution or a confidential information management system of a national institution.

As described above, the system according to the present embodiment is an extremely comprehensive and advanced care support system that acquires and manages the biometric data and the daily life activity history of the care recipient and various information inside and outside the facility in real time and from multiple angles, and simultaneously realizes an individually optimized care proposal, staff allocation optimization, sophistication of facility operation, infectious disease risk dispersion, comfortable environment maintenance, strengthening of cooperation with a family member and a medical worker, a disaster response, long-term health risk prediction, and the like with the generative AI as a core. Specifically, the system constructs a distributed processing architecture in which an edge device group and a cloud server group are tightly coupled. The system executes a lightweight inference model on an edge side to perform real-time abnormality detection. The system executes complex context understanding and long-term prediction calculation using a large language model on a cloud side. The system integrates calculation results of both via an asynchronous messaging queue. The system executes feature amount extraction, dimensionality reduction, and clustering on an input huge multimodal data stream in a parallel processing pipeline. The system dynamically embeds the processed data as a prompt context of the generative AI. The system verifies an output result of the generative AI with a rule-based expert system, and generates a safe control command from which hallucination is eliminated. The system instantaneously clarifies a correlation of multivariate data exceeding a human cognitive limit by these advanced information processing mechanisms. The system brings about a technical effect of eliminating a personalized judgment error in a care site and achieving complete optimization of a business process. The system functions not merely as a business efficiency improvement tool but as a next-generation computing platform that realizes data-driven autonomous facility operation. The system directly contributes to construction of a wide-area healthcare network that integrally manages a plurality of facilities.

### (Implementation Steps)

### Step 1: Real-time Acquisition of Biometric Data and Daily Life Activity History

Various biometric data such as a heart rate, a blood pressure, a body temperature, a blood oxygen concentration, a step count, a sleep state, a stress index, a respiratory rate, fall detection, an activity amount, a skin temperature, a sweating amount, a body weight, a food intake, an excretion frequency, a urine volume, a stool property, a swallowing state, a cough or a respiratory sound, facial expression recognition, and a subjective physical condition declaration by voice recognition are automatically acquired in real time or at regular intervals using a wearable device, a bed sensor, a clothes built-in sensor, a smartphone, an environmental sensor, or the like worn by the care recipient, and furthermore, a daily life activity history such as a meal, excretion, bathing, medication, rehabilitation, recreation, movement, changing clothes, gymnastics, going out, a visit, sleep, awakening, a rest, swallowing training, oral care, nail clipping, a walk, shopping, a hobby activity, a learning activity, television viewing, music appreciation, gardening, pet care, and a video call with a family member is automatically acquired from a tablet terminal or a voice input of a care staff, a sensor device, an IoT home appliance, a smart lock, smart lighting, a smart home appliance, or the like, and is recorded and managed in chronological order. Specifically, in this step, a microcontroller of each sensor device activates a data acquisition routine triggered by an interrupt signal from a built-in timer. In this step, the microcontroller amplifies a minute voltage change from an analog sensor with an amplifier circuit, and converts the minute voltage change into a discrete digital value using an analog-to-digital converter. In this step, a processor in an edge device executes a fast Fourier transform on an array of the acquired digital values, and extracts a feature amount in a frequency domain. In this step, the processor inputs the extracted feature amount to an edge AI model, and excludes noise or an artifact in real time. In this step, the processor serializes valid biometric data and text data of a daily life activity input by the staff into a payload in a JSON format. In this step, the processor writes the serialized data to a local ring buffer memory. In this step, for example, the processor acquires a 3-axis acceleration tensor sampled at 100 Hz as input data, and calculates a probability distribution of a behavior label such as walking, falling, or resting as output data. In this step, the processor adopts only a label whose probability exceeds a predetermined threshold as confirmed data. In this step, these hardware-level signal processings provide a technical effect of saving a subsequent communication bandwidth and significantly reducing a calculation load on the server side. This step is based on a technical foundation similar to a data collection process in condition monitoring of mechanical equipment in a factory or performance analysis of an athlete.

### Step 2: Server Transmission and Accumulation/Integrated Management of Data

The acquired biometric data and daily life activity history are uploaded from the terminal to the server in real time or at regular intervals via a communication line such as 4G, 5G, Wi-Fi, or a wired LAN, and are accumulated in a database on the server side in association with an anonymized ID. Thereby, it becomes possible to integrally manage a health condition, a life pattern, a long-term change, a transition of an abnormal value, a life rhythm, an activity tendency, a social interaction status, and the like for each care recipient from multiple angles. Specifically, in this step, a communication module on the terminal side reads data from the ring buffer memory, and generates a publish message based on an MQTT protocol. In this step, the communication module transmits the generated message to a message broker on the server side via a TCP/IP socket. In this step, a load balancer on the server side dynamically distributes processing to a plurality of worker nodes according to an amount of received traffic. In this step, the worker node deserializes a payload of the message, and executes schema verification of the data. In this step, the worker node writes the data that has passed the verification to a memory cache of a distributed NoSQL database. In this step, a database management system collects the data in the memory cache into a certain chunk size, and flushes the data to a persistent storage in a background process. In this step, the database management system automatically generates a B-tree index using the anonymized ID of the care recipient and a time stamp as a composite key. In this step, for example, a heart rate vector transmitted every second is received as input data, and a statistical value vector downsampled in units of one hour is generated as output data and stored in another table. In this step, this hierarchical data accumulation architecture realizes a technical effect of guaranteeing a query response speed in units of milliseconds even for petabyte-class large-scale data. This step applies a data pipeline technology applied to tick data storage of a financial transaction or a log collection system of a large-scale E-commerce site.

### Step 3: Real-time Grasping of Facility Status and Staff Status

The facility status management unit acquires a congestion degree, a use status, a cleaning and disinfection status, an infectious disease risk dispersion status, a ventilation state, temperature and humidity, an illuminance, a noise level, an operation status of equipment, an evacuation route in a disaster, an open/closed status of an emergency exit, stockpile management, power consumption, a water supply and drainage status, an operation status of air conditioning equipment, an operation status of an IoT home appliance, and the like of each room and equipment in the facility in real time from a sensor or an IoT device, and further simultaneously grasps a current location, a working status, a specialized skill, an assignment history, shift information, qualification information, years of experience, a fatigue level or a stress index, a desired shift, compatibility between staffs, an emergency response history, and the like of a staff, and integrally manages them on the server. Specifically, in this step, the facility status management unit executes a data fusion process of combining data streams asynchronously arriving from heterogeneous data sources into a data frame on a memory. In this step, the facility status management unit registers spatial coordinate data of each sensor in a spatial database using an R-tree index. In this step, the facility status management unit inputs a radio wave intensity from a beacon terminal possessed by the staff to a Kalman filter, removes noise, and calculates an accurate two-dimensional coordinate vector. In this step, the facility status management unit collates the calculated coordinate vector with the spatial database, and specifies which room each staff is staying in. In this step, the facility status management unit calculates an inner product of a skill set vector of the staff and a request vector of the care recipient, and calculates a fitness score. In this step, the facility status management unit expands these pieces of information on the memory as directed graph data composed of nodes and edges. In this step, for example, a temperature array of each room and a position coordinate array of the staff are received as input data, and a heat map tensor and a resource distribution matrix of the entire facility are generated as output data. In this step, the generated matrix data is used as an initial state of a subsequent optimization algorithm. In this step, a technical effect of constructing a digital twin is brought about by accurately mapping a status of a physical space to a computable data structure on a cyber space. This step is an indispensable process in traffic flow monitoring in a smart city or operation status monitoring of a huge plant.

### Step 4: Generation of Individually Optimized Care Proposal by Generative AI

The care proposal generation unit comprehensively analyzes the biometric data, the daily life activity history, a past behavior pattern, a health condition, a psychological state, and a life rhythm of the care recipient, a congestion status in the facility, weather, infectious disease epidemic information, a request from a family member, an instruction of a doctor, a care plan document, a dietary restriction, allergy information, a rehabilitation goal, a dementia progression degree, a fall risk evaluation, a bedsore risk evaluation, a swallowing risk evaluation, medication management, a sleep disorder, a depressive tendency, a social isolation risk, a seasonal disease risk, a disaster response plan, and the like using the generative AI, and dynamically generates an optimal care plan, a timing of a rest, rehabilitation, and recreation, an optimal timing of a meal, bathing, and medication, personalized communication, an exercise and meal proposal, dementia care, a fall prevention program, swallowing training, oral care, social interaction promotion, a hobby activity proposal, life rhythm adjustment, sleep improvement, stress relief, seasonal disease prevention, disaster evacuation support, and the like for each care recipient. Specific examples of a prompt sentence to be read by the generative AI include “The heart rate of the care recipient is 105, the blood pressure is 110/70, the body temperature is 36.8, and the latest activity is a meal. Propose an activity to be recommended next and a necessary staff response.”, “The sleep time of the care recipient is short, and there are many nocturnal awakenings. Propose an activity amount adjustment in the daytime and a sleep improvement measure.”, and the like. Specifically, in this step, the care proposal generation unit executes a prompt engineering process of automatically embedding the integrated multidimensional data into a prompt template of a natural language. In this step, the care proposal generation unit converts the generated prompt character string into an integer index array using a tokenizer. In this step, the care proposal generation unit multiplies the index array by a word embedding matrix to generate an input tensor of a continuous value. In this step, the care proposal generation unit forward-propagates the input tensor to a multi-layer encoder and decoder block of a transformer model. In this step, the transformer model calculates a weight of relevance between a numerical value “heart rate 105” and a context “latest activity is a meal”, for example, using a multi-head attention mechanism. In this step, a final layer of the model applies a softmax function to output a probability distribution vector for a vocabulary size. In this step, the care proposal generation unit searches for a token sequence having the highest cumulative probability using a beam search algorithm, and generates a proposal text of a natural language. In this step, the care proposal generation unit inputs the generated text to a rule-based safety filter, and verifies whether a dangerous instruction violating a medical guideline is included. In this step, for example, a context array of 500 tokens is given as an input, and a text “prompt hydration and instruct a rest for 30 minutes” and a reliability score of 0.95 are obtained as an output. In this step, this advanced inference process realizes a technical effect of executing complex decision making based on a huge number of variables faster and more accurately than a human. This step plays a role equivalent to a decision-making engine in route planning of an autonomous vehicle or algorithmic trading in a financial market.

### Step 5: Execution of Staff Allocation and Business Optimization by Generative AI

A staff allocation optimization unit comprehensively analyzes a current location, a working status, a specialized skill, an assignment history, shift information, qualification information, years of experience of a staff, a congestion degree in a facility, a health condition and an activity history of a care recipient, an infectious disease risk dispersion status, an emergency response history, a fatigue level and a stress index of the staff, a desired shift of the staff, compatibility among staffs, a cooperation status with a family and a medical staff, and the like, and automatically generates in real time an optimal patrol route, an assignment, a shift adjustment, a response priority in an emergency, business load dispersion, an education and training plan, a timing of a rest, infectious disease zoning, a disaster response, and the like for each staff using generative AI. Specific examples of a prompt sentence to be read by the generative AI include “Staff A is available, staff B is busy, and a congestion degree of a rehabilitation room is 1. Propose an optimal assignment for each staff.”, “There are a plurality of care recipients with a high fall risk during a night time zone. Propose an optimal assignment of a patrol staff and a patrol order.”, and the like. Specifically, in this step, the staff allocation optimization unit supplies a situation vector of the entire facility and a state vector of each staff to an input layer of a deep reinforcement learning model. In this step, the deep reinforcement learning model calculates a mapping from a state space to an action space using a multilayer perceptron. In this step, the model outputs a matrix of an action value function (Q value) indicating a combination of task assignments to each staff. In this step, the staff allocation optimization unit selects an assignment pattern that maximizes the Q value. In this step, the staff allocation optimization unit evaluates an objective function that brings a response delay of a highly urgent task close to zero while minimizing a total movement distance of each staff based on the selected pattern. In this step, the staff allocation optimization unit inputs, for example, a position coordinate matrix of three staffs, a requested task vector of five care recipients, and a route network graph in the facility as input data. In this step, the staff allocation optimization unit generates a permutation vector indicating a task execution order of each staff and an array of scheduled completion times as output data. In this step, the generated schedule is passed to a subsequent task dispatcher module and used for asynchronous message transmission to each terminal. In this step, the staff allocation optimization unit calculates an error between an actual required time and a predicted time after task completion, and updates a weight of the model using an error backpropagation method. In this step, this dynamic optimization provides a technical effect of maximizing an operation rate of limited human resources and eliminating a business bottleneck. This step is widely applied to a dispatch algorithm of a ride-sharing service and virtual machine scheduling of cloud computing.

### Step 6: Information Presentation and Feedback Acquisition by a User Interface

A user interface unit provides a function capable of intuitively operating and browsing a care proposal, a facility status, staff allocation, feedback input, an emergency response, visualization of a life rhythm, a transition of a health condition, an alert notification, a video call, a chat, a questionnaire, a reminder, schedule management, and the like on a terminal of a care recipient, a staff, a family, and a medical staff, transmits feedback and operation data from the care recipient, the family, and the staff to a server, and utilizes them for continuous learning of generative AI. Specifically, in this step, the user interface unit parses schedule data and care proposal data in a JSON format received from the server, and updates a state management object on a memory. In this step, the user interface unit detects a change in state and re-renders a UI component in accordance with a paradigm of reactive programming. In this step, the user interface unit pop-up displays a proposal content on a display of the terminal, and waits for a tap event of approval or rejection from a user. In this step, the user interface unit acquires coordinates and a timestamp of the tap event, and encodes them as a feedback vector. In this step, the user interface unit transmits the feedback vector to a learning data collection endpoint of the server via a REST API. In this step, a batch processing program on the server side constructs a learning data set by pairing the accumulated feedback vector and an original input tensor. In this step, the server executes a gradient descent method using a GPU cluster, and fine-tunes a parameter of a generative AI model. In this step, for example, text data “proposal: hydration, result: rejection, reason: already drank water just before” is vectorized and input as input data, and a gradient vector of a loss function of the model is calculated as output data. In this step, this continuous feedback loop realizes a technical effect that the system absorbs tacit knowledge in the field and improves inference accuracy over time. This step is an indispensable process in improvement of a ranking algorithm of a search engine and personalization of a recommendation system.

### Step 7: Security Management and Privacy Protection

A security management unit applies a quantum cryptography communication technology and a privacy-preserving machine learning technology to communication between a terminal and a server, strictly manages personal information, health data, and an activity history of a care recipient so as not to be leaked to the outside, and implements a privacy management function capable of finely setting a use range and a storage period of data, presence or absence of third-party provision, anonymization of feedback, and the like in accordance with a request of the care recipient and a family. Specifically, in this step, the security management unit executes an elliptic curve Diffie-Hellman key exchange algorithm to securely generate a common session key when establishing a communication session between the terminal and the server. In this step, the security management unit applies AES-256-GCM encryption to all payload data to be transmitted, and generates a ciphertext and an authentication tag. In this step, the security management unit verifies the authentication tag on a receiving side, and detects falsification of data in the middle of a communication path. In this step, the security management unit applies k-anonymization and l-diversity algorithms to biometric data stored in a database, and converts the data into a format in which an individual cannot be identified. In this step, the security management unit receives, for example, a record array including a real name, an age, and a detailed medical history of the care recipient as input data, and generates an anonymized record array replaced with a hashed ID, an age group, and a generalized disease name as output data. In this step, the security management unit receives a setting change request from the terminal of a user, and dynamically rewrites a flag of an access control list in the database. In this step, when a data provision request to a third-party system occurs, the security management unit refers to the access control list, extracts only a permitted data field, and generates a JSON response. In this step, these strict encryption and access control processes provide a technical effect of completely satisfying a strict compliance requirement such as a medical information protection law. This step is a security architecture standardly adopted in network cooperation of an electronic medical record system and a confidential data sharing infrastructure of a government agency.

### (Specific Use Case)

For example, in a care facility, when a plurality of care recipients have different health conditions, life rhythms, hobbies and preferences, rehabilitation goals, medication schedules, and social interaction statuses, each care recipient wears a smartwatch-type wearable device, and acquires various biometric data such as a heart rate, a blood pressure, a body temperature, a blood oxygen concentration, a step count, a sleep state, a stress index, fall detection, an activity amount, a skin temperature, a sweating amount, a meal intake amount, an excretion frequency, a swallowing state, a cough and a respiratory sound, facial expression recognition, and a subjective physical condition declaration by voice recognition in real time. Furthermore, a daily life activity history such as a meal, excretion, bathing, medication, rehabilitation, recreation, movement, changing clothes, gymnastics, going out, a visit, sleep, a rest, swallowing training, oral care, a hobby activity, watching television, listening to music, gardening, pet care, and a video call with a family is automatically acquired from a tablet terminal of a care staff, voice input, a sensor device, an IoT home appliance, a smart lock, and the like, and recorded and managed in chronological order. A facility status management unit acquires a congestion degree, a use status, a cleaning and disinfection status, a ventilation state, temperature and humidity, illuminance, a noise level, an operation status of equipment, an evacuation route in a disaster, stockpile management, and the like of a rehabilitation room, a dining room, a bathroom, a toilet, a recreation room, and the like in real time from a sensor and an IoT device, and a staff allocation optimization unit simultaneously grasps a current location, a working status, a specialized skill, an assignment history, shift information, qualification information, years of experience, a fatigue level and a stress index, a desired shift, compatibility among staffs, an emergency response history, and the like of a staff. Specifically, in this use case, each smartwatch-type wearable device samples raw data at a frequency of 100 times per second from a built-in photoplethysmography sensor and a 6-axis inertial measurement unit. In this use case, a microprocessor in the device applies a Kalman filter to the raw data to remove body movement noise, and extracts a feature vector of a heart rate and a step count. In this use case, the device transmits the extracted feature vector to an edge gateway arranged in the facility using a Bluetooth Low Energy protocol. In this use case, the edge gateway aggregates data streams from a plurality of devices, and transfers them to a cloud server via a distributed messaging system such as Apache Kafka. In this use case, a stream processing engine on the cloud server combines the received biometric data vector and an environmental data vector acquired from the IoT home appliance using a timestamp as a key. In this use case, the stream processing engine caches the combined multidimensional time-series tensor in an in-memory database. In this use case, the facility status management unit inputs an image tensor acquired from a network camera to an object detection model such as YOLO, and outputs bounding box coordinates of a person in each room. In this use case, the facility status management unit calculates a congestion degree score from the number of bounding boxes, and updates the database. In this use case, this series of data pipeline processing realizes a technical effect of replicating every physical state in the facility on a cyberspace with a delay in milliseconds. This use case functions as a system that centrally manages dynamics of hundreds of patients and staffs in real time in a large-scale hospital or care facility.

Based on such multilayered data, a care proposal generation unit dynamically generates an optimal care plan using generative AI for a situation such as, for example, “Care recipient A has a heart rate of 110, a blood pressure of 100/60, a body temperature of 37.5, a latest activity is rehabilitation, a sleep time is short and night awakenings are frequent, rehabilitation has been performed in the morning, afternoon recreation is desired, a meal intake amount is small, a fall risk is high, a dementia progression degree is moderate, there is a depressive tendency, an interaction frequency with a family is low, a congestion degree of a rehabilitation room is 2, staff B is available, and staff C is busy”. Specifically, the care proposal generation unit makes an individually optimized proposal such as “propose a rest and hydration to the care recipient A before the afternoon recreation, adjust the recreation to a time zone with a low congestion degree, assign watching by the staff B in consideration of the fall risk, and incorporate a video call with the family and a hobby activity (music therapy, gardening activity) based on the depressive tendency and a social isolation risk”. Furthermore, a staff allocation optimization unit assigns the staff B to be in charge of watching the recreation of the care recipient A, instructs the staff C to patrol another high-risk care recipient, and simultaneously optimizes an overall business load and infectious disease risk dispersion. Specifically, in this use case, the care proposal generation unit combines a biometric data vector, a past behavior history matrix of the care recipient A, and a facility environment vector to construct a 1024-dimensional input tensor. In this use case, the care proposal generation unit inputs this input tensor to a transformer-based generative AI model. In this use case, the generative AI model assigns a high attention weight between elements of “heart rate 110” and “high fall risk” using a self-attention mechanism. In this use case, the generative AI model outputs a text token sequence indicating a sequence of recommended actions and an execution probability score of each action as output data. In this use case, for example, the model generates an output of “rest (score 0.95)”, “hydration (score 0.92)”, and “recreation with watching (score 0.88)”. In this use case, the staff allocation optimization unit inputs this output result and a state matrix of the staff to a deep reinforcement learning model. In this use case, the deep reinforcement learning model outputs an optimization matrix that assigns the staff B to a task of the care recipient A and assigns the staff C to another patrol route. In this use case, the system transmits a JSON payload for a push notification to a smartphone of each staff based on this optimization matrix. In this use case, the smartphone of the staff receives the payload and renders a specific instruction content and a route map on a screen. In this use case, this advanced cooperation processing brings about a technical effect of completely eliminating a delay and a mistake in personal judgment, and instantaneously redistributing limited human resources to a place where they are most needed. This use case provides a computer science optimal solution to a dynamic task assignment problem under a complex constraint condition.

In addition, a facility status management unit automatically adjusts a use time and the number of people when a congestion degree of a rehabilitation room increases, and automatically controls air conditioning equipment and a ventilation fan when insufficient ventilation or high temperature and high humidity is detected. The facility status management unit restricts entry to a room where cleaning and disinfection have not been performed, automatically manages an evacuation route, an opening/closing status of an emergency exit, a remaining amount of stockpiles, and an arrangement of an evacuation guidance staff in a disaster, and realizes rapid evacuation support. A user interface unit provides a function capable of intuitively operating and browsing a care proposal, a facility status, staff allocation, feedback input, an emergency response, visualization of a life rhythm, a transition of a health condition, an alert notification, a video call, a chat, a questionnaire, a reminder, schedule management, and the like on a terminal by a care recipient, a staff, a family, and a medical staff. Specifically, this system analyzes multidimensional time-series data acquired from an environmental sensor group. This analysis unit evaluates a fluctuation of an environment in real time using an anomaly detection algorithm. This control unit directly drives hardware such as the air conditioning equipment based on an evaluation result. Thereby, this system automates environment maintenance and safety management in a facility, and improves operation efficiency.

Specific examples of a prompt sentence to be read by generative AI include “Care recipient A has a heart rate of 110, a blood pressure of 100/60, a body temperature of 37.5, a latest activity is rehabilitation, a sleep time is short and night awakenings are frequent, afternoon recreation is desired, a meal intake amount is small, a fall risk is high, a dementia progression degree is moderate, there is a depressive tendency, an interaction frequency with a family is low, a congestion degree of a rehabilitation room is 2, staff B is available, and staff C is busy. Propose an optimal care plan and staff assignment.”, “Automatically generate a use time adjustment and air conditioning control when a congestion degree of a rehabilitation room increases and insufficient ventilation is detected, an entry restriction to a room where cleaning has not been performed, and an evacuation guidance plan in a disaster.”, and the like. Specifically, this generation module maps input natural language text to a vector space. This large language model calculates a context dependency relationship using a self-attention mechanism. This model outputs a probability distribution of an optimal care plan based on a calculation result. This system executes subsequent staff assignment processing using this output, and realizes business optimization.

As described above, the system of the present invention is an extremely comprehensive and advanced care support system that acquires and manages biometric data and a daily life activity history of a care recipient, and various information inside and outside a facility in real time and from multiple angles, and simultaneously realizes an individually optimized care proposal, staff allocation optimization, sophistication of facility operation, infectious disease risk dispersion, comfortable environment maintenance, strengthening of cooperation with a family and a medical staff, a disaster response, and the like with generative AI as a core. Specifically, this integrated system operates by linking a plurality of neural network models. This data processing unit integrates various input streams and executes feature extraction. This inference engine applies a prediction model based on the extracted feature. Thereby, this system eliminates personalization of a care business and enables data-driven decision making.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

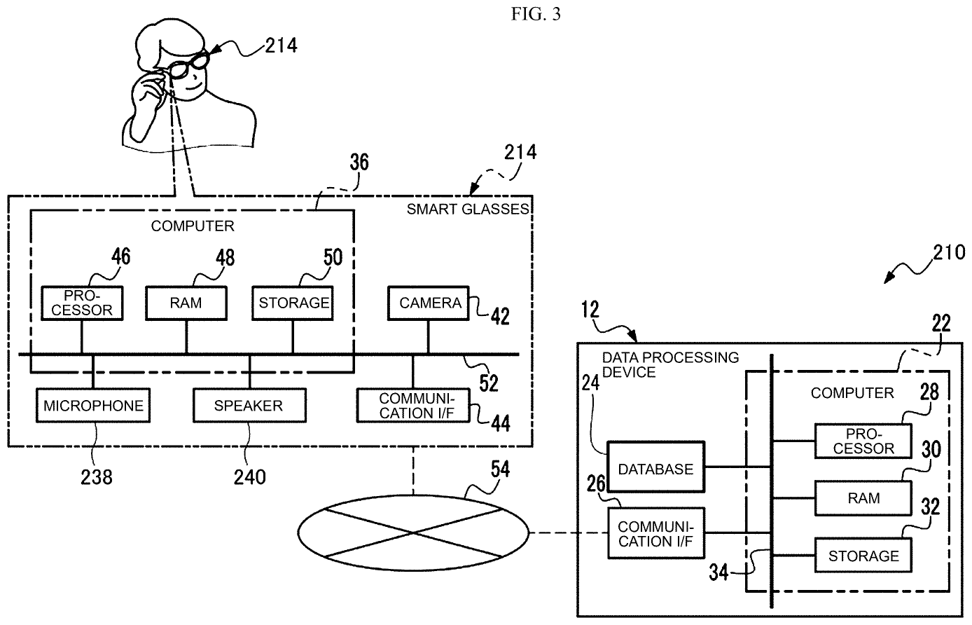

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

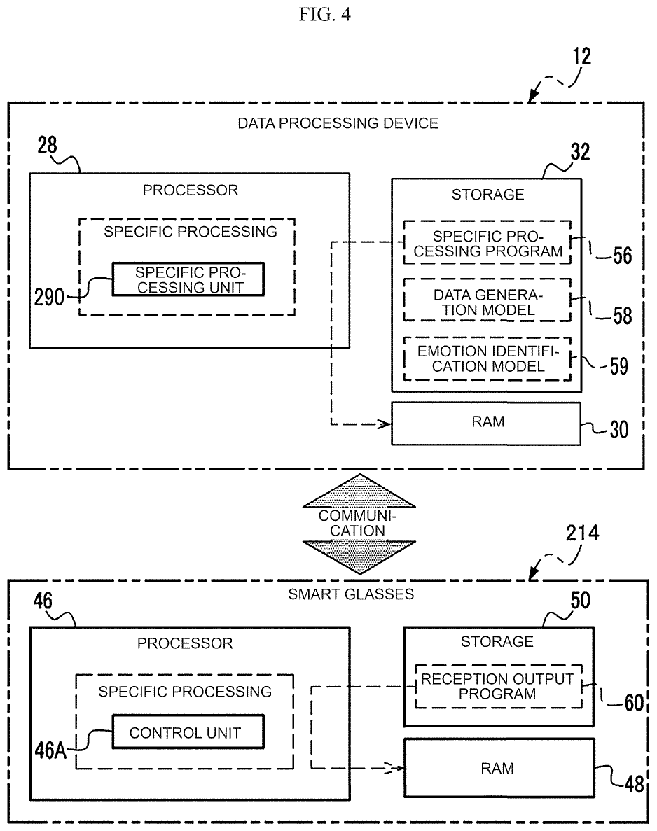

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### EXAMPLE 1

Since the flow of the specific processing is the same as that in Example 1 described in the first embodiment, the description thereof is omitted. (Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

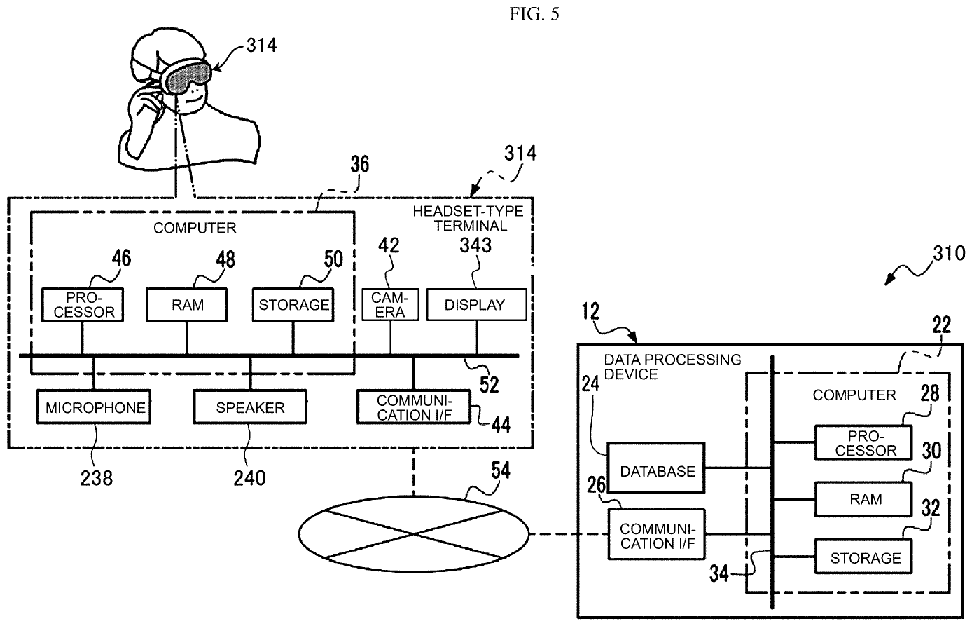

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

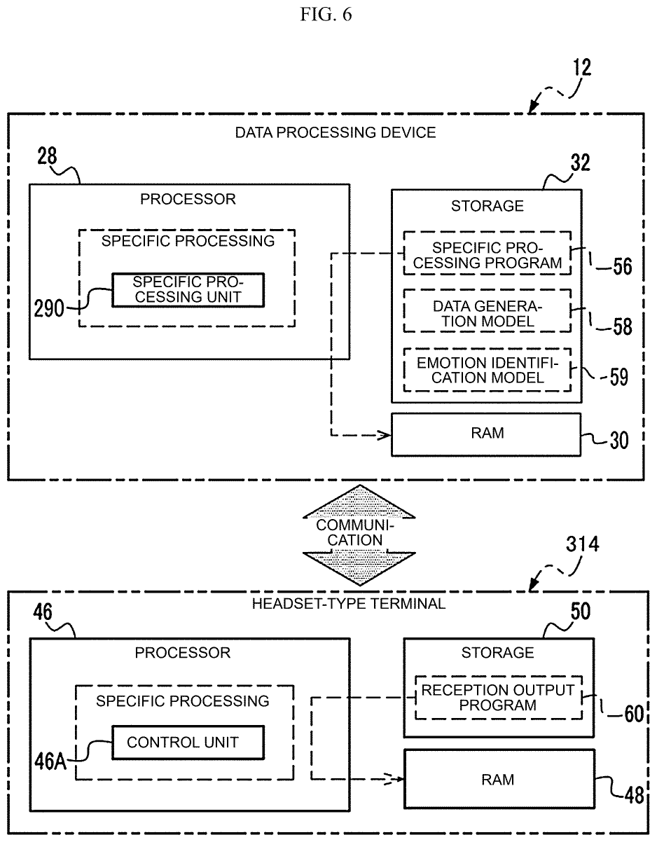

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

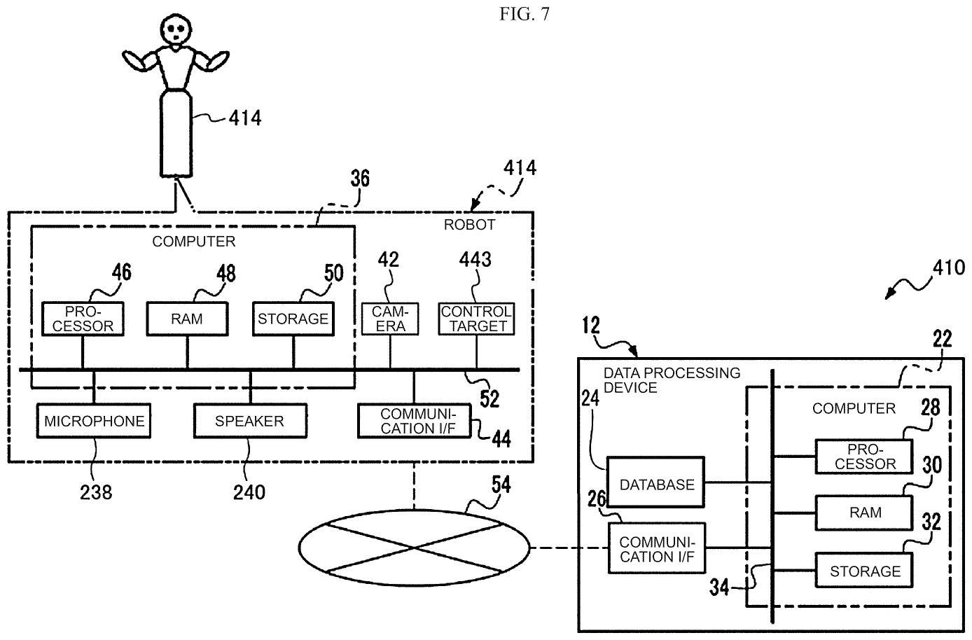

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

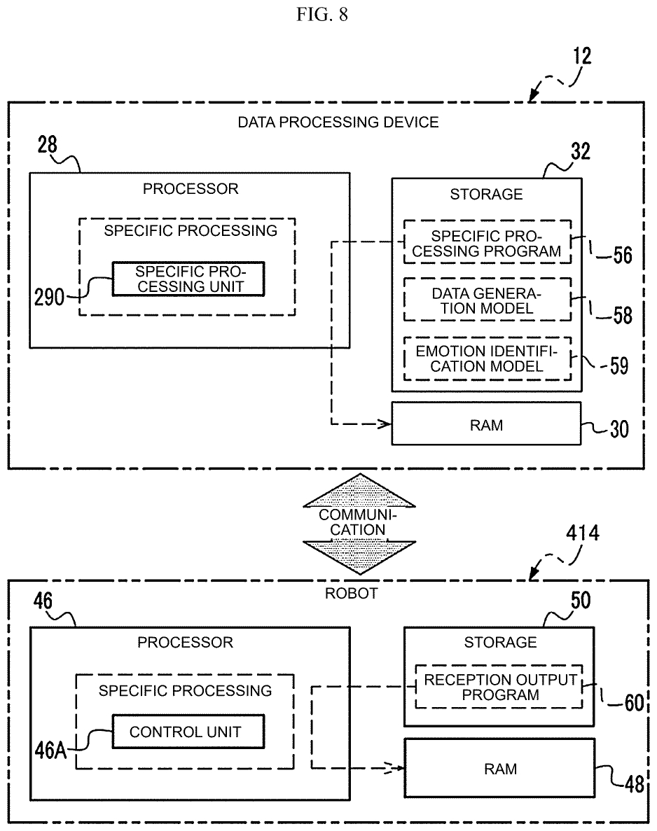

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

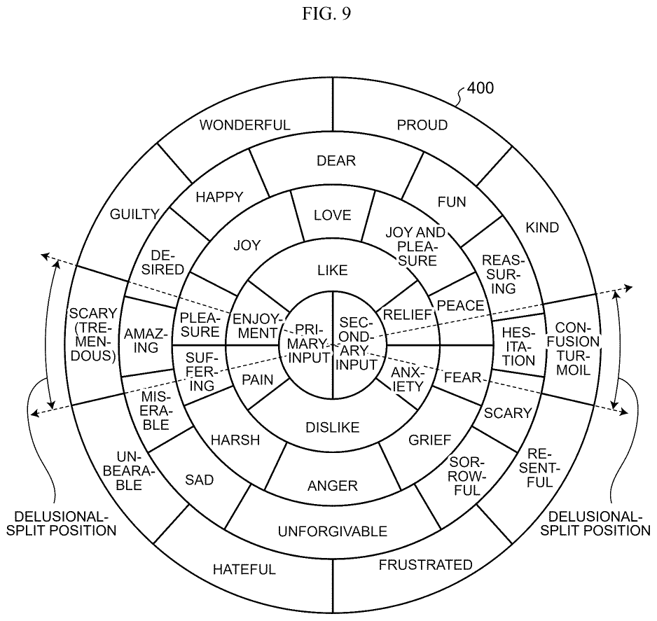

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

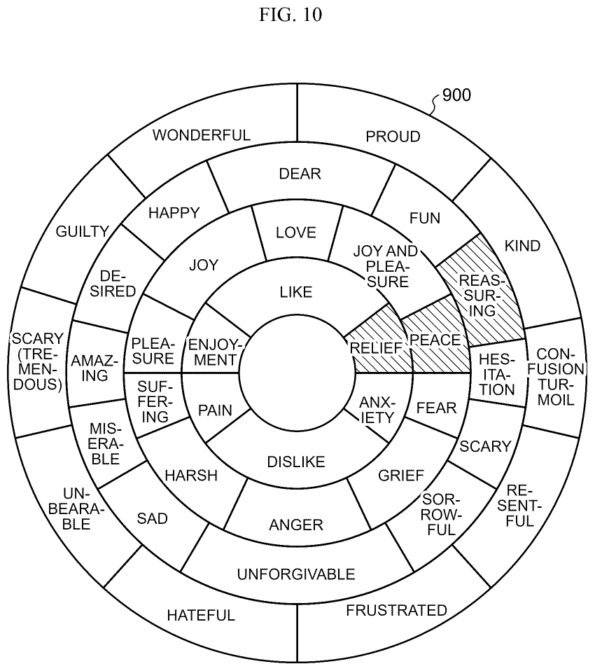

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising: a biometric data acquisition unit; a daily life activity history management unit; a care proposal generation unit; a staff allocation optimization unit; and a facility status management unit, wherein the biometric data acquisition unit is configured to acquire biometric data such as a heart rate, a blood pressure, a body temperature, a blood oxygen concentration, a step count, a sleep state, and a stress index in real time or at regular intervals from a wearable device or a terminal worn by a care recipient; the daily life activity history management unit is configured to automatically acquire a daily life activity history such as a meal, excretion, bathing, medication, rehabilitation, recreation, and movement from an input of a care staff or a sensor device, and record and manage the daily life activity history in chronological order; the care proposal generation unit is configured to comprehensively analyze the biometric data and the daily life activity history, a past behavior pattern, a health condition, a psychological state, and a life rhythm of the care recipient, a congestion status in a facility, weather, infectious disease epidemic information, and the like using generative AI, and dynamically generate an optimal care plan, a timing of a rest, rehabilitation, and recreation, an optimal timing of a meal, bathing, and medication, personalized communication, an exercise and meal proposal, and the like for each care recipient; the staff allocation optimization unit is configured to optimize patrols and an assignment by the generative AI based on a current location, a working status, a specialized skill, and an assignment history of a staff, a congestion degree in the facility, and a state of the care recipient; and the facility status management unit is configured to grasp a congestion degree, a use status, a cleaning and disinfection status, an infectious disease risk dispersion status, and the like of each room and equipment in the facility in real time, and provide information to the care proposal generation unit and the staff allocation optimization unit.

### (Supplementary Note 2)

The system according to Supplementary Note 1, wherein the care proposal generation unit includes a process of, when a heart rate, a body temperature, or the like exceeds a predetermined threshold based on the biometric data of the care recipient, preferentially proposing a check by a medical staff or a rest, and when there is no abnormality, dynamically generating rehabilitation, recreation, individual exercise, personalized communication, an optimal timing of a meal, bathing, and medication, and the like using the generative AI in consideration of a latest activity history, a congestion status in the facility, and a preference and the life rhythm of the care recipient, and presenting the generated information to the care recipient and the staff.

### (Supplementary Note 3)

The system according to Supplementary Note 1, wherein the staff allocation optimization unit comprehensively analyzes a current location, a working status, a specialized skill, and an assignment history of a staff, a congestion degree in the facility, a health condition and an activity history of the care recipient, an infectious disease risk dispersion status, and the like, automatically generates in real time an optimal patrol route, an assignment, a shift adjustment, a response priority in an emergency, and the like for each staff using the generative AI, and simultaneously realizes efficiency of facility operation and safety and security of the care recipient.

What is claimed is:

1. A system comprising:
circuitry configured to:
receive, via a communication interface coupled to a packet-switched network, heterogeneous streaming data from a plurality of IoT sensor devices distributed across a facility environment, execute primary filtering and feature extraction at an edge gateway to generate compressed feature vectors, and transmit the compressed feature vectors to a cloud computing node via the communication interface;
retrieve structured operational records from external data service endpoints via the communication interface, and apply a generative neural network model to the compressed feature vectors and the structured operational records to generate a multi-dimensional state assessment vector comprising a plurality of condition indicator dimensions and a requirement prediction score;
apply a resource allocation optimization model to the multi-dimensional state assessment vectors and an available capacity record to generate an operational scheduling data record comprising optimized assignment sequences and resource distribution parameters;
apply an autoencoder model pre-trained on normal operating conditions to the compressed feature vectors to compute reconstruction error scores, and generate an emergency alert data record when a reconstruction error score exceeds an emergency threshold parameter; and
transmit the multi-dimensional state assessment vectors, the operational scheduling data record, and the emergency alert data record to terminal devices via the communication interface.

2. The system according to claim 1, wherein the circuitry is configured to receive streaming data from environmental sensor devices comprising temperature values, humidity values, and motion detection event flags at the edge gateway, apply a noise filter, and transmit compressed feature vectors representing summarized environmental state parameters to the cloud computing node to reduce communication traffic.

3. The system according to claim 2, wherein the circuitry is configured to apply an event-driven data collection module at the edge gateway that processes streaming data asynchronously, add timestamps to received data, apply a noise removal filter, and transmit only filtered and timestamped data payloads to the cloud computing node via the communication interface.

4. The system according to claim 1, wherein the circuitry is configured to receive sensor parameter data from wearable monitoring devices at a predetermined sampling rate via the communication interface, normalize the received values against individual baseline parameter records stored in the storage device, and compute parameter deviation scores for incorporation in the multi-dimensional state assessment vector.

5. The system according to claim 4, wherein the circuitry is configured to apply the generative neural network model to the compressed feature vectors, parameter deviation scores, and longitudinal monitoring record data to generate the multi-dimensional state assessment vector comprising current condition status parameters and a requirement prediction score.

6. The system according to claim 5, wherein the circuitry is configured to accumulate multi-dimensional state assessment vectors in a longitudinal monitoring record in the storage device, apply a trend analysis model to extract state trajectory patterns over configurable time windows, and generate a deterioration trend indicator when a sustained adverse trajectory is detected.

7. The system according to claim 1, wherein the circuitry is configured to apply the resource allocation optimization model by formulating a constraint satisfaction problem that assigns tasks from the operational scheduling data record to available resource identifiers while satisfying qualification constraint parameters and workload capacity constraint parameters, and solve the constraint satisfaction problem using an iterative optimization algorithm.

8. The system according to claim 7, wherein the circuitry is configured to update the operational scheduling data record in real time when new multi-dimensional state assessment vectors indicate changes in condition indicator dimensions, and transmit updated scheduling notifications to affected terminal devices via the communication interface.

9. The system according to claim 1, wherein the circuitry is configured to apply the autoencoder model to the compressed feature vectors by computing reconstruction error between the input feature vector and the autoencoder decoder output, classify detected anomaly events by type using a multi-class classification model, and generate the emergency alert data record comprising an anomaly type identifier, a current timestamp, and a location identifier.

10. The system according to claim 9, wherein the circuitry is configured to transmit the emergency alert data record to terminal devices associated with designated responder user identifiers and to an emergency response service endpoint via the communication interface, and update a response tracking record when acknowledgment responses are received from the terminal devices.

11. The system according to claim 1, wherein the circuitry is configured to apply a retrieval-augmented generation process to the multi-dimensional state assessment vectors by retrieving relevant reference guideline records from a vector database by cosine similarity search, and generating personalized action plan recommendation data comprising prioritized operational sequences.

12. The system according to claim 11, wherein the circuitry is configured to transmit the personalized action plan recommendation data to terminal devices associated with designated personnel user identifiers, receive implementation status updates from the terminal devices via the communication interface, and update the longitudinal monitoring record with the implementation status data.

13. The system according to claim 1, wherein the circuitry is configured to monitor for risk concentration events by applying a spatial proximity analysis model to position tracking data from sensor devices, compute a proximity exposure score when proximity thresholds are exceeded, and generate a risk dispersion alert data record when a proximity exposure score exceeds a risk threshold parameter.

14. The system according to claim 1, wherein the circuitry is configured to generate a facility operational overview data record by aggregating multi-dimensional state assessment vectors, operational scheduling data record status, and sensor environment state data across all monitored zones, and transmit the overview data record to terminal devices associated with management user identifiers.

15. The system according to claim 1, wherein the circuitry is configured to generate a performance insight report from historical multi-dimensional state assessment vectors and corresponding validated outcome records, apply the generative neural network model to compute prediction accuracy metrics, and transmit the report to terminal devices associated with management user identifiers at configurable periodic intervals.

16. The system according to claim 1, wherein the circuitry is configured to encrypt data transmissions between IoT sensor devices and the system using a transport layer security protocol, and enforce a privacy access control policy restricting access to compressed feature vectors and multi-dimensional state assessment vectors to authorized user identifiers.

17. The system according to claim 1, wherein the IoT sensor devices are distributed across facility zones and comprise environmental sensor devices and wearable monitoring devices, the edge gateway performs primary filtering to reduce cloud communication load, and the operational scheduling data record assigns tasks to resources based on multi-dimensional state assessment scores.

18. A system comprising:
circuitry configured to:
receive, via a communication interface coupled to a packet-switched network, heterogeneous streaming data from IoT sensor devices, execute primary filtering at an edge gateway to generate compressed feature vectors, and transmit to a cloud computing node;
apply a generative neural network model to the compressed feature vectors and structured operational records to generate multi-dimensional state assessment vectors comprising condition indicator dimensions and requirement prediction scores;
apply a resource allocation optimization model to generate operational scheduling data records comprising optimized assignment sequences and resource distribution parameters;
apply an autoencoder anomaly model to generate emergency alert data records when reconstruction error exceeds a threshold; and
transmit multi-dimensional state assessment vectors, operational scheduling data records, and emergency alert data records to terminal devices via the communication interface.

19. The system according to claim 18, wherein the circuitry is configured to apply a spatial proximity analysis model to generate risk concentration alerts, apply a trend analysis model to longitudinal monitoring records to detect deterioration trends, and generate facility operational overview data records by aggregating state assessment vectors and operational scheduling status across all monitored zones.

20. A method comprising:
receiving, via a communication interface coupled to a packet-switched network, heterogeneous streaming data from a plurality of IoT sensor devices distributed across a facility environment, executing primary filtering at an edge gateway to generate compressed feature vectors, and transmitting to a cloud computing node;
retrieving structured operational records from external data service endpoints and applying a generative neural network model to generate multi-dimensional state assessment vectors comprising condition indicator dimensions and a requirement prediction score;
applying a resource allocation optimization model to generate an operational scheduling data record comprising optimized assignment sequences and resource distribution parameters;
applying an autoencoder model to compute reconstruction error scores and generating an emergency alert data record when a score exceeds an emergency threshold; and
transmitting the multi-dimensional state assessment vectors, the operational scheduling data record, and the emergency alert data record to terminal devices via the communication interface.
